(19) United States
(12) Patent Application Publication
(10) Pub. No.: US 2022/0405689 A1
(43) Pub. Date: Dec. 22, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: YURI KUSAKABE, TOKYO (JP); SEIJI SUZUKI, TOKYO (JP)

(21) Appl. No.: 17/755,134

(22) PCT Filed: Sep. 15, 2020
(86) PCT No.: PCT/JP2020/034821

§ 371 Date: Apr. 21, 2022

(30) Foreign Application Priority Data
Oct. 30, 2019 (JP) 2019-197871

(51) Int. Cl. G06Q 10/06

(52) U.S. Cl. CPC G06Q 10/063114

(57) ABSTRACT

An information processing apparatus (100) according to the present disclosure includes a control unit (170). The control unit (170) detects free time of a user (U) based on behavior information on behavior of the user (U). When detecting the free time, the control unit (170) determines a task to be presented to the user (U) from a plurality of tasks.

### FIELD

The present disclosure relates to an information processing apparatus, an information processing method, and a program.

### BACKGROUND

In recent years, techniques for presenting various pieces of information to users have been developed. For example, a technique for presenting information that is likely to be related to a user at right timing is known (e.g., see Patent Literature 1). In such a technique, a history of user operation of a device is recorded. When the user starts operating the device, the next operation of the user is estimated with reference to the operation history, and appropriate information is presented to the user based on the estimation result.

### CITATION LIST

### Patent Literature

Patent Literature 1: JP 2017-33482 A

### SUMMARY

### Technical Problem

The above-described information output apparatus according to the related art, however, merely outputs information when a user executes a task (operates device). For example, when there is a plurality of tasks to be executed, a user selects a task to be executed. The user selection may prevent efficient task execution. As described above, in the related art, there is room for improvement in that a user efficiently executes a task.

Therefore, the present disclosure proposes an information processing apparatus, an information processing method, and a program capable of proposing efficient task execution to a user.

### Solution to Problem

According to the present disclosure, an information processing apparatus is provided. The information processing apparatus includes a control unit. The control unit detects free time of a user based on behavior information on behavior of the user. When detecting the free time, the control unit determines a task to be presented to the user from a plurality of tasks.

### BRIEF DESCRIPTION OF DRAWINGS

FIG. 1 outlines an information processing system according to an embodiment of the present disclosure.

FIG. 2 illustrates a configuration example of the information processing system according to the embodiment of the present disclosure.

FIG. 3 illustrates installation places for an output apparatus and a sensor apparatus according to the embodiment of the present disclosure.

FIG. 4 illustrates one example of a task DB according to the embodiment of the present disclosure.

FIG. 5 illustrates presentation of task information performed by an output control unit.

FIG. 6 is a view (1) illustrating another example of task information presentation performed by the output control unit.

FIG. 7 is a view (2) illustrating another example of the task information presentation performed by the output control unit.

FIG. 8 is a flowchart illustrating a procedure of task registration processing according to the embodiment of the present disclosure.

FIG. 9 is a sequence diagram illustrating detection of task start.

FIG. 10 is a sequence diagram illustrating another example of the detection of task start.

FIG. 11 is a sequence diagram illustrating recognition of an execution user.

FIG. 12 is a sequence diagram illustrating another example of the recognition of the execution user.

FIG. 13 illustrates correction of a result of recognizing the execution user.

FIG. 14 is a flowchart illustrating position detection processing.

FIG. 15 is a flowchart illustrating another example of the position detection processing.

FIG. 16 is a sequence diagram illustrating detection of task end.

FIG. 17 is a sequence diagram illustrating another example of the detection of task end.

FIG. 18 is a flowchart illustrating a procedure of task presentation processing according to the embodiment of the present disclosure.

FIG. 19 is a block diagram illustrating one example of a hardware configuration of the information processing apparatus according to the present embodiment.

### DESCRIPTION OF EMBODIMENTS

An embodiment of the present disclosure will be described in detail below with reference to the drawings. Note that, in the following embodiment, the same reference signs are attached to the same parts to omit duplicate description.

Furthermore, the present disclosure will be described in accordance with the following item order.

1. Embodiment

1-1. Outline of Information Processing System According to Embodiment

1-2. Configuration of Information Processing System According to Embodiment

1-3. Procedure of Information Processing According to Embodiment

2. Other Configuration Examples

3. Hardware Configuration

### 1. Embodiment

[1-1. Outline of Information Processing System According to Embodiment]

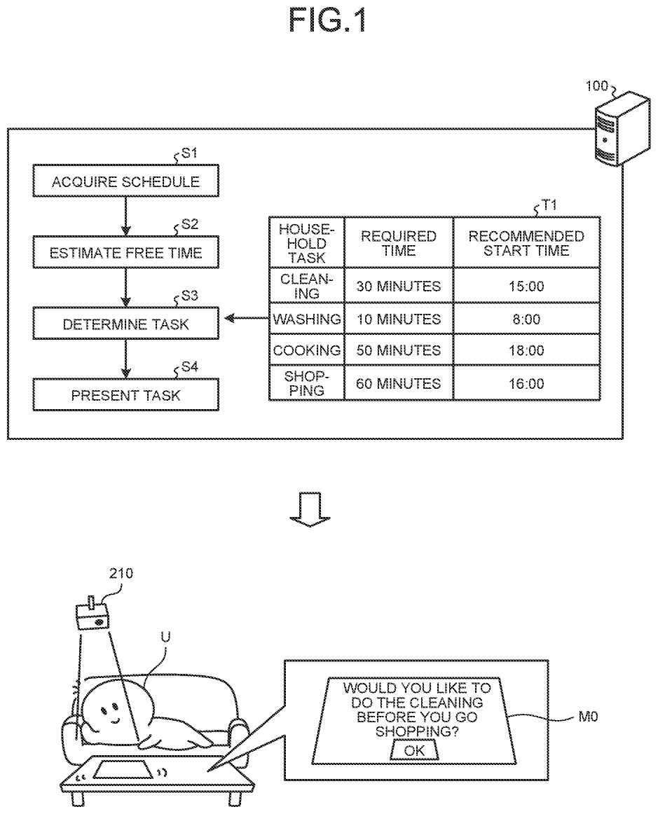

First, an information processing system according to an embodiment of the present disclosure will be outlined with reference to FIG. 1. FIG. 1 outlines the information processing system according to the embodiment of the present disclosure. The information processing system according to the present embodiment presents a task (here, household task) recommended to be executed to a user U in accordance with behavior information on the user U. The information processing system includes an information processing apparatus 100 and a moving projector 210.

The moving projector 210 is an apparatus that outputs various pieces of information from the information processing apparatus 100. The moving projector 210 projects various pieces of information by using any place (region), such as a wall, a floor, and furniture included in space where the moving projector 210 is installed, as a projection place (projection surface or projection region). Note that the projection place is not limited to a flat surface. The projection place may be a curved surface, or may be divided into a plurality of surfaces.

The information processing apparatus 100 executes presentation processing of presenting a task to the user U in accordance with the behavior information on the user U. The information processing apparatus 100 controls the moving projector 210 to present a task to the user U, for example.

Specifically, the information processing apparatus 100 acquires, for example, a schedule of the user U as the behavior information on the user U (Step S1). Here, for example, the information processing apparatus 100 is assumed to have acquired a schedule of “shopping from 15:00” as a schedule of the User U.

Next, the information processing apparatus 100 estimates free time of the user U (Step S2). For example, when the current time, in other words, the time when the information processing apparatus 100 has acquired the schedule of the user U is 14:00, the information processing apparatus 100 estimates that the time from 14:00 to 15:00 is the free time of the user U.

The information processing apparatus 100 determines a task that can be executed by the user U within the free time based on a task database T1 (Step S3). The information processing apparatus 100 selects, for example, a task that requires time shorter than the free time. Furthermore, a task whose time when the start of the task is recommended (recommended start time) is close to the current time may be selected. Note that the user U may designate the recommended start time. Alternatively, the information processing apparatus 100 may preliminarily determine the recommended start time from the time when the user U usually executes the task. Here, the information processing apparatus 100 is assumed to have determined “cleaning”, whose recommended start time is close to the current time (14:00), as a task to be presented to the user U.

The information processing apparatus 100 presents the determined task to the user U (Step S4). For example, in the example in FIG. 1, the information processing apparatus 100 controls the moving projector 210 to project an image M0 including a sentence “Would you like to do the cleaning before you go shopping?” onto a table, thereby proposing execution of the task to the user U lying on a sofa.

As described above, the information processing apparatus 100 according to the embodiment of the present disclosure estimates free time of the user U based on the behavior information (here, schedule) on the user U. When the user U is in free time, the information processing apparatus 100 presents a task in accordance with the free time to the user U. This allows the information processing apparatus 100 to propose efficient task execution to the user U.

[1-2. Configuration of Information Processing System According to Embodiment]

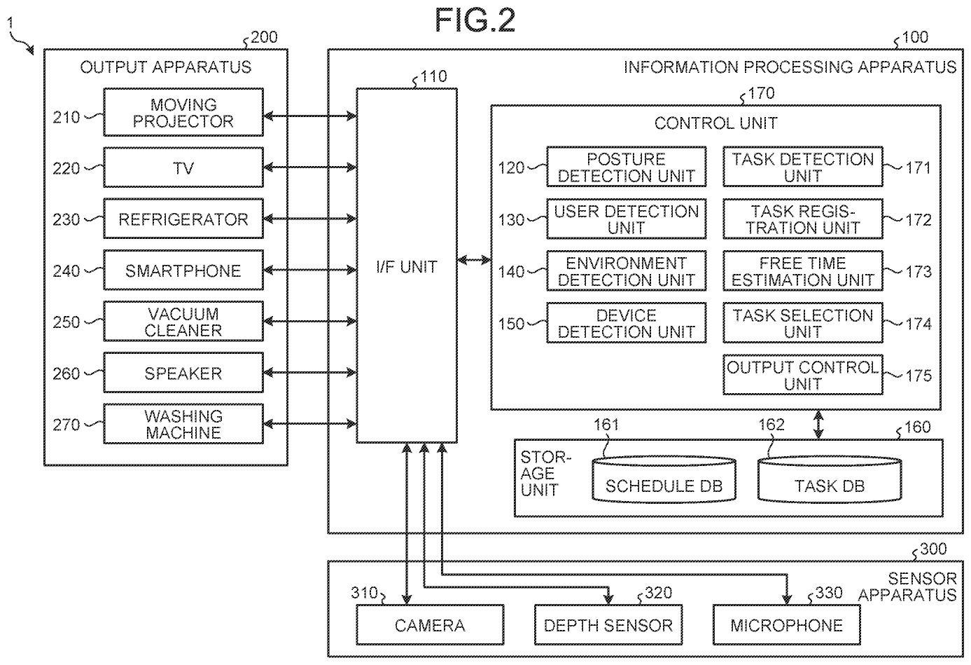

FIG. 2 illustrates a configuration example of an information processing system 1 according to the embodiment of the present disclosure. As illustrated in FIG. 2, the information processing system 1 includes the information processing apparatus 100, an output apparatus 200, and a sensor apparatus 300.

(Output Apparatus)

The output apparatus 200 includes stationary apparatuses and portable apparatuses (moving objects). The stationary apparatuses are installed on furniture, a wall, and a ceiling, and include the moving projector 210, a TV 220, a refrigerator 230, a washing machine 270, and a speaker 260. The portable apparatuses (moving objects) include a smartphone 240 and a vacuum cleaner 250. In other words, the output apparatus 200 includes an apparatus for which space (room) to be used is preliminarily determined (device in which room is associated with apparatus) and an apparatus for which a room to be used is not preliminarily predetermined (device in which room is not associated with apparatus).

The moving projector 210 is a projection apparatus that projects an image onto any place in space. The moving projector 210 includes a movable unit (not illustrated) of, for example, a pan/tilt drive type. The movable unit can change a projection direction. Note that the output apparatus 200 may include a fixed-type wide-angle projector instead of the moving projector 210, or may include both the moving projector 210 and the fixed-type projector.

The TV 220 is an apparatus that receives radio waves for television broadcasting and outputs an image and voice. Furthermore, the TV 220 outputs an image and voice under the control of the information processing apparatus 100. The smartphone 240 is a mobile device capable of wireless communication, and is an apparatus that outputs an image, voice, vibration, and the like. The smartphone 240 outputs an image, voice, vibration, and the like under the control of the information processing apparatus 100.

The speaker 260 is an apparatus that outputs (reproduces) voice data. The speaker 260 outputs voice under the control of the information processing apparatus 100. Furthermore, the speaker 260 may output voice of the moving projector 210 and the TV 220.

The refrigerator 230, the washing machine 270, and the vacuum cleaner 250 are apparatuses (tools) used when the user U executes a task. Here, such an apparatus can output an image, voice, buzzer sound, and the like from a display, a speaker, and the like.

Note that each apparatus of the output apparatus 200 is one example, and this is not a limitation. The output apparatus 200 may include, for example, a tablet terminal, a personal computer (PC), and a wearable terminal other than the above-described apparatuses. Alternatively, the output apparatus 200 may include an apparatus used for executing a task (household task), such as a stove and a fan, other than the vacuum cleaner 250 and the refrigerator 230. Furthermore, the output apparatus 200 may include a lighting system, an air conditioner, a music reproducing apparatus, and the like.

Note that the output apparatus 200 is required to include at least one of the above-described apparatuses, and is not necessarily required to include all the apparatuses. An apparatus of the output apparatus 200 can be appropriately changed by addition, deletion, or the like. Furthermore, when a plurality of users U uses the smartphones 240, the output apparatus 200 includes the smartphones 240 of the users U. As described above, the output apparatus 200 may include a plurality of apparatuses of the same type.

(Sensor Apparatus)

The sensor apparatus 300 includes, for example, a camera 310, a depth sensor 320, and a microphone 330.

The camera 310 is an imaging apparatus that includes a lens system, a drive system, and an imaging element, and that captures an image (still image or moving image), such as an RGB camera. The depth sensor 320 is an apparatus that acquires depth information, such as an infrared distance measuring apparatus, an ultrasonic distance measuring apparatus, laser imaging detection and ranging (LiDAR), and a stereo camera. The microphone 330 is an apparatus that collects ambient voice and outputs voice data converted into a digital signal via an amplifier and an analog digital converter (ADC).

Note that each apparatus of the sensor apparatus 300 is one example, and this is not a limitation. The sensor apparatus 300 may include an apparatus to which the user U inputs information, such as a mouse, a keyboard, a touch panel, a button, a switch, and a lever, other than the above-described apparatuses. Alternatively, the sensor apparatus 300 may include various sensors such as a fingerprint recognition sensor that recognizes a fingerprint, an acceleration sensor, a gyro sensor, a geomagnetic sensor, an optical sensor, an illuminance sensor, and a force sensor.

Furthermore, although the output apparatus 200 and the sensor apparatus 300 are separate in FIG. 2, this is not a limitation. For example, the camera 310 may be mounted on the smartphone 240, the moving projector 210, and the like. Furthermore, the speaker 260 may be a smart speaker mounted with the microphone 330. The sensor apparatus 300 may be installed in space (room) where the sensor apparatus 300 is used alone. Alternatively, the sensor apparatus 300 may be mounted on the output apparatus 200, and may function as a part of the output apparatus 200.

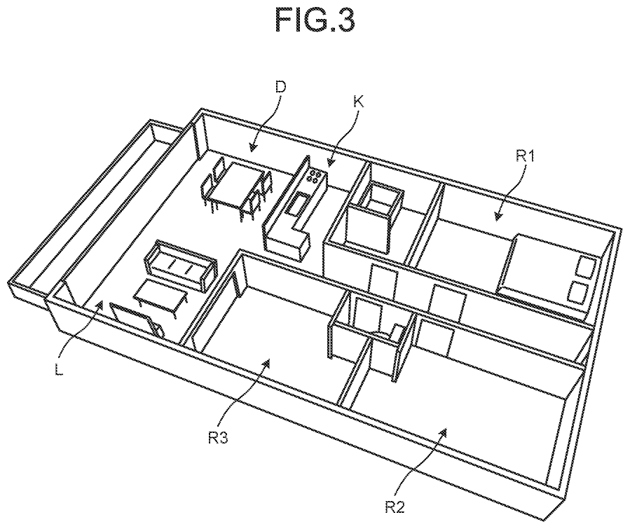

Here, a place where the output apparatus 200 and the sensor apparatus 300 are installed will be described with reference to FIG. 3. FIG. 3 illustrates installation places for the output apparatus 200 and the sensor apparatus 300 according to the embodiment of the present disclosure.

Although the output apparatus 200 and the sensor apparatus 300 are not illustrated in FIG. 3, the output apparatus 200 and the sensor apparatus 300 are installed in each room of a home, such as a living room L, a dining room D, a kitchen K, a main bedroom R1, a kids room R2, and a Japanese room R3. For example, the moving projector 210 mounted with the camera 310 is installed on the ceiling of the living room L. Furthermore, the smart speaker mounted with the speaker 260 and the microphone 330 is installed in, for example, the living room L, the main bedroom R1, and the kids room R2.

Note that, here, for example, the camera 310 mounted on the moving projector 210 can capture an image of the situation of the living room L, the dining room D, and the kitchen K. In contrast, in consideration of privacy, the camera 310 is not installed in the main bedroom R1, the kids room R2, and the like. The camera 310 cannot capture an image of the situation of these rooms.

Furthermore, unless otherwise specified, the description will be given below on the assumption that a plurality of users U includes three of a husband, a wife, and a son who live in a home in FIG. 3.

(Information Processing Apparatus)

Returning to FIG. 2, the information processing apparatus 100 includes an interface (I/F) unit 110, a storage unit 160, and a control unit 170.

(I/F Unit)

The I/F unit 110 is a connection apparatus for connecting the information processing apparatus 100 with another apparatus (e.g., output apparatus 200 and sensor apparatus 300). The I/F unit 110 is a communication interface for communication with another apparatus.

In the case, the I/F unit 110 may be a network interface or a device connection interface. For example, the I/F unit 110 may be a local area network (LAN) interface such as a network interface card (NIC), or may be a USB interface including a universal serial bus (USB) host controller, a USB port, and the like.

Note that the I/F unit 110 may be a wired interface or a wireless interface. The I/F unit 110 functions as a communication device of the information processing apparatus 100. The I/F unit 110 communicates with another apparatus under the control of the control unit 170.

(Storage Unit)

The storage unit 160 is a data readable/writable storage apparatus such as a dynamic random access memory (DRAM), a static random access memory (SRAM), a flash memory, and a hard disk. The storage unit 160 functions as a storage device of the information processing apparatus 100. The storage unit 160 includes a schedule database 161 and a task database 162.

The storage unit 160 stores posture information, user information, environment information, device information, and the like. A posture detection unit 120 detects the posture information. A user detection unit 130 detects the user information. An environment detection unit 140 detects the environment information. A device detection unit 150 detects the device information.

(Schedule Database)

A schedule database (DB) 161 stores information on a schedule of the user U, such as scheduled going out and a task scheduled to be executed. When schedules of a plurality of users U are stored, the schedule DB 161 stores a schedule for each user U. The user U or the information processing apparatus 100 may register a schedule to the schedule DB 161. Schedule registration performed by the information processing apparatus 100 will be described later. Note that a schedule of the user U may be appropriately acquired from the smartphone 240, an external server, or the like without being held by the information processing apparatus 100.

(Task Database)

A task database (DB) 162 stores information on a task executed by the user U. In the present embodiment, the task DB 162 stores information on a household task.

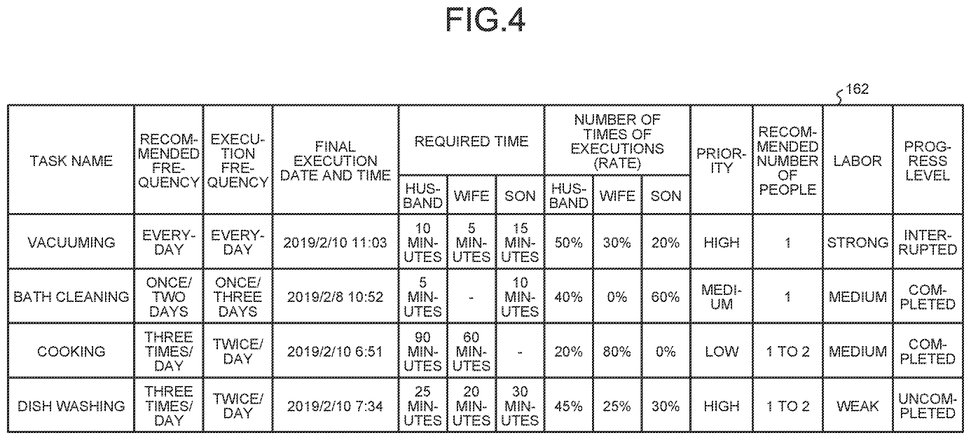

FIG. 4 illustrates one example of the task DB 162. FIG. 4 illustrates one example of the task DB 162 according to the embodiment of the present disclosure. In the example in FIG. 4, the task DB 162 stores, for each task, information such as “recommended frequency”, “execution frequency”, “final execution date and time”, “required time”, “number of times of executions”, “priority”, “recommended number of people”, “strength”, and “progress level”.

The “recommended frequency” is information indicating a frequency at which task execution is recommended. In the example in FIG. 4, the “recommended frequency” of a “vacuuming” task is “everyday”, and the “recommended frequency” of a “cooking” task is “three times/day” (three times a day). The “recommended frequency” may be preset, or may be set by the user U. Alternatively, the “recommended frequency” may be an average value of intervals at which a task is executed, or may be calculated from the “execution frequency”.

Note that, although the task DB 162 stores information indicating the frequency at which task execution is recommended here, this is not a limitation. For example, the task DB 162 may store information on date and time when task execution is recommended as “recommended start time” (see task database T1 in FIG. 1). The “recommended start time” is calculated from the “final execution date and time” and the “recommended frequency”, or the “final execution date and time” and the “execution frequency”. Alternatively, the user U may set the “recommended start time”.

The “execution frequency” is information indicating the frequency of task execution. The “execution frequency” is calculated from, for example, a past execution interval of a task. In the example of FIG. 4, the “execution frequency” of a “bath cleaning” task is “once/three days” (once every three days). The “execution frequency” of a “dish washing” task is “twice/day” (twice a day).

Note that, although the above-described “recommended frequency” and “execution frequency” are set in units of date, this is not a limitation. The “recommended frequency” and the “execution frequency” may be set in units of time, for example, “every 24 h”.

The “final execution date and time” is information indicating the date and time when a task was finally executed. In the example in FIG. 4, the “final execution date and time” of the “vacuuming” task is 11:03 on Feb. 10, 2019.

The “required time” is information indicating a time required for task execution. When a plurality of users U executes a task, the task DB 162 stores “required time” for each user U. The “required time” is, for example, an average value of task execution times when the task was executed in the past. Alternatively, the “required time” may be the task execution time taken when the task was finally executed.

In the example in FIG. 4, the task DB 162 stores “required times” of the three of the “husband”, the “wife”, and the “son” corresponding to the plurality of users U. For example, the “required time” of the “cooking” task of the “husband” and that of the “wife” are “90 minutes” and “60 minutes”, respectively. Furthermore, for example, the “required time” of the “son” who has no experience of executing the “cooking” task is indicated by “-”.

The “number of times of executions (rate)” is information indicating the rate of the number of times that the user U executes a task. The “number of times of executions (rate)” indicates the rate of the number of times that the user U executed a task to all the number of times of executions of the task. When a plurality of users U executes a task, the task DB 162 stores the “number of times of executions (rate)” for each user U. In the example in FIG. 4, the “numbers of times of executions (rate)” of three of the “husband”, the “wife”, and the “son” corresponding to the plurality of users U are stored. For example, the “number of times of executions (rate)” of the “cooking” task of the “husband” and that of the “wife” are “20%” and “80%”, respectively. Furthermore, for example, the “number of times of executions (rate)” of the “son” who has no experience of executing the “cooking” task is “0%”.

Note that, although the task DB 162 stores the “number of times of executions (rate)” here, for example, the task DB 162 may store the cumulative number of times of executions. In this case, the task DB 162 may store the number of times of task executions from the start of task registration to the present, or may store the number of times of task executions during a predetermined period from the present.

For example, the number of times of executions of a task that the user U is good at is larger than the number of times of executions of a task that the user U is not good at. As described above, the task DB 162 stores the number of times of task executions, and thereby the task DB 162 can store the compatibility between the user U and the task. Note that the task compatibility may be stored by the user U registering whether or not the user U likes the task in the task DB 162 for each task, for example.

The “priority” is information indicating whether or not execution of a task is to be prioritized. For example, the “priority” of the task is set in accordance with the elapsed time from recommended start time. Furthermore, when one of related tasks such as the “cooking” task and the “dish washing” task (e.g., “cooking”) is completed, the “priority” of the other task (e.g., “dish washing”) is set high.

Furthermore, for example, when a task is interrupted, for example, when the “vacuuming” task is not executed for all rooms and interrupted halfway, the “priority” is set high. Furthermore, for example, when the recommended start time is a past time before the current time, that is, when a task execution deadline has passed, the “priority” is also set high. As described above, the “priority” is set in accordance with a task execution deadline (e.g., recommended start time). Note that the task execution deadline is not limited to the recommended start time, and may be a deadline by which a task is to be actually completed, such as a deadline of payment of public utility charges or the like and a deadline of submitting a document to be submitted to a school or the like. In this case, the “priority” is set in accordance with a period to a task execution deadline. For example, the “priority” becomes higher as the execution deadline approaches.

Furthermore, the “priority” may be set in accordance with the importance of a task. For example, the “cooking” task may be more important than the “vacuuming” task for the user U, and vice versa. As described above, the importance of a task may vary depending on the users U. Therefore, a task in accordance with importance can be registered in the task DB 162 by, for example, setting the “priority” of an important task to be high.

Note that the user U sets the importance of a task. Alternatively, the information processing apparatus 100 may perform estimation based on, for example, a task selected by the user U at the time when a plurality of tasks is presented.

The “recommended number of people” is information indicating the number of people recommended to participate in execution of a task. For example, the recommended number of people for a task executed in a narrow place such as “bathroom cleaning” is as small as one person. When a task execution range is wide or a heavy object such as furniture needs to be moved, for example, when “window cleaning” and “room waxing” are performed, the large recommended number of people for the task is set. Note that the “recommended number of people” may be preset, or may be set by the user U. Alternatively, the task DB 162 may store the number of people who have actually participated in task execution as the “recommended number of people” for the next task.

The “strength” is information indicating a load (labor) applied to task execution. For example, “strength” of “high” is set for a task having a high load, such as a task in which a heavy burden needs to be carried and a task having a long execution time. Furthermore, “strength” of “low” is set for a task having a low load, such as a task that a person can perform while being seated and a task having a short execution time. Furthermore, the “strength” may be set in accordance with the situation of space where a task is executed. For example, in the case of a house without the stairs, the “strength” of “medium” is set for the “vacuuming” task, but in the case of a house of two-story or more with the stairs, “high” is set for the task.

The “progress level” is information indicating the progress of task execution. For example, when a task is completed, the “progress level” is registered as “completed”. When a schedule of task execution is registered in a schedule, the “progress level” is registered as “uncompleted”. Furthermore, a task that has been interrupted halfway is registered as “interrupted”, for example. Note that the “progress level” of the interrupted task may include not only the state of the task of “interrupted”, but a part of a completed task or a part of an uncompleted task. For example, in the case of the “cooking” task, the completed task includes “preparation” and the like, and the uncompleted task includes “serving” and the like.

Note that, although the “progress level” is information indicating a task state, such as “completed”, “uncompleted”, and “interrupted” here, this is not a limitation. The “progress level” may be, for example, a percentage such as “0%” and “100%”.

Note that the task DB 162 in FIG. 4 is one example. The task DB 162 may include information other than the above-described items, and is not required to include some information. For example, the task DB 162 may store “difficulty level” of a task in addition to the above-described items. The “difficulty level” of a task is information indicating, for example, the difficulty of task execution. For example, high “difficulty level” is set for a task that needs use of fire or a knife or a task having a complicated procedure, such as the “cooking” task.

(Control Unit)

Returning to FIG. 2, the control unit 170 is a controller that controls each unit of the information processing apparatus 100. For example, the control unit 170 is implemented by a processor such as a central processing unit (CPU) and a micro processing unit (MPU). The control unit 170 may be configured to control an image processor that is provided outside the control unit 170 and executes each piece of information processing to be described later, or may be configured to be capable of executing each piece of information processing by the control unit 170 itself. For example, the function of the control unit 170 is implemented by a processor executing various programs stored in a storage apparatus in the information processing apparatus 100 by using a random access memory (RAM) or the like as a work area. Note that the control unit 170 may be implemented by an integrated circuit such as an application specific integrated circuit (ASIC) and a field programmable gate array (FPGA). Any of the CPU, the MPU, the ASIC, and the FPGA can be regarded as a controller.

As illustrated in FIG. 2, the control unit 170 includes the posture detection unit 120, the user detection unit 130, the environment detection unit 140, the device detection unit 150, a task detection unit 171, a task registration unit 172, an estimation unit 173, a task selection unit 174, and an output control unit 175. The control unit 170 implements or executes the function and effects of information processing to be described below. Each block constituting the control unit 170 is a functional block exhibiting the function of the control unit 170. These functional blocks may be software blocks or hardware blocks. For example, each of the above-described functional blocks may be one software module implemented by software (including microprogram), or may be one circuit block on a semiconductor chip (die). Of course, each functional block may be one processor or one integrated circuit. Any method of constituting a functional block can be adopted. Note that the control unit 170 may include a functional unit different from the above-described functional blocks.

(Posture Detection Unit)

The posture detection unit 120 has a function of detecting posture information on the user U based on information sensed by the sensor apparatus 300. The posture detection unit 120 detects the orientation, inclination, and movement of the body of the user U as posture information based on, for example, a captured image of the camera 310, a depth map of the depth sensor 320, and the like. For example, the posture detection unit 120 detects a lying state, a sitting state, a standing state, leaning forward, leaning back, and the like of the user U as the posture information.

For example, the posture detection unit 120 recognizes bone information and the center position of the user U by performing predetermined image processing (e.g., estimation processing based on deep learning) on the captured image of the camera 310. Note that the bone information relates to the states of the bones and joints of the user U, and is used for processing of recognizing the posture of the user U. Furthermore, the center position of the user U is, for example, an average value of the position coordinates of each joint. The posture detection unit 120 detects the posture information on the user U based on the bone information and the center position of the user U.

Note that the posture detection unit 120 may detect the posture information on the user U by using a sensor apparatus other than the camera 310 and the depth sensor 320. For example, the posture detection unit 120 may detect the posture information on the user U based on a sensing result of a thermo camera, an ultrasonic sensor, and the like. Furthermore, the posture information detected by the above-described posture detection unit 120 is one example, and this is not a limitation. The posture detection unit 120 may detect, for example, gesture information on the user U as the posture information.

(User Detection Unit)

The user detection unit 130 has a function of detecting information on the user U (user information) based on information sensed by the sensor apparatus 300.

For example, the user information includes information indicating the positions and number of the users U in space sensed by the sensor apparatus 300. The user detection unit 130 detects the positions and number of the users U based on, for example, a captured image of the camera 310, a depth map of the depth sensor 320, and the like. Alternatively, the user detection unit 130 may detect the positions and number of the users U based on a thermo camera, an infrared sensor, an ultrasonic sensor, or the like.

The user information includes information indicating the line of sight of the user U, for example. The information indicating the line of sight of the user U includes information indicating the position of a viewpoint and a line-of-sight direction. Furthermore, the information indicating the line of sight of the user U may indicate the orientations of the face and head of the user, or may indicate the orientation of an eyeball.

The user detection unit 130 detects the line of sight of the user U based on, for example, a captured image of the camera 310. Alternatively, the user detection unit 130 may perform the detection by analyzing an image of an eye of the user U obtained by an infrared camera, an eyepiece camera mounted on the user U, or the like.

The user information includes information indicating uttered voice of the user U. The user detection unit 130 detects the uttered voice of the user U based on, for example, voice data of the microphone 330.

Note that the above-described user information is one example, and one or a combination of a plurality of pieces of user information may be included. Furthermore, the above-described user information may include information other than the above-described information. For example, the user information may include user identification information indicating who the detected user U is.

(Environment Detection Unit)

The environment detection unit 140 has a function of detecting environment information based on information sensed by the sensor apparatus 300. The environment information relates to space which the user U is in.

The environment information includes information indicating the shape of the space which the user U is in, for example. The information indicating the shape of space includes information indicating the shape of an object forming the space, such as a wall surface, a ceiling, a floor, a door, furniture, and daily supplies. The information indicating the shape of space may be two-dimensional information or three-dimensional information such as a point cloud. The environment detection unit 140 detects the information indicating the shape of space based on, for example, depth information obtained by the depth sensor 320.

The environment information includes information indicating the state of a projection surface, for example. The state of a projection surface means, for example, unevenness and color of the projection surface. The environment detection unit 140 detects the unevenness of the projection surface based on, for example, the depth information obtained by the depth sensor 320. The environment detection unit 140 detects the color of the projection surface by analyzing an image captured by the camera 310, for example.

The environment information includes information indicating the brightness of the projection surface. The environment detection unit 140 detects the brightness of the projection surface from an image captured by the camera 310, for example. Alternatively, the environment detection unit 140 may detect the brightness of the projection surface from an illuminance sensor, for example.

The environment information includes information indicating the position (three-dimensional position) of an object in space, for example. The environment detection unit 140 detects the positions of a cup, a chair, a table, an electronic device, and the like in a room by, for example, image recognition based on an image captured by the camera 310. Furthermore, the position of an electronic device that performs wireless communication, such as the smartphone 240 and a PC, may be detected based on, for example, radio field strength related to communication with an access point of a wireless LAN.

The environmental information includes, for example, environmental sound. The environment detection unit 140 detects the environmental sound based on, for example, voice data of the microphone 330.

Note that the above-described environment information is one example, and one or a combination of a plurality of pieces of above-described environment information may be included. Furthermore, the above-described environment information may include information other than the above-described information. For example, the environment information may include space use information indicating what the detected space is used for. The space use information includes information on space where the information processing system 1 collects information and provides information, such as the living room L, the kitchen K, and the kids room R2.

Note that, although a case where the environment detection unit 140 detects environment information has been described here, this is not a limitation. For example, the user U himself/herself may input information on the shape of space which the user U is in. Alternatively, the information processing system 1 may preliminarily perform acquisition based on real estate information and the like.

(Device Detection Unit)

The device detection unit 150 has a function of detecting information (device information) on a device in space. The device information includes, for example, the presence of a device and the three-dimensional position of the device.

As described above, the information processing apparatus 100 is connected to each device including the output apparatus 200 via the I/F unit 110. For example, the I/F unit 110 is connected to each device in space by a wireless/wired local area network (LAN), digital living network alliance (DLNA (registered trademark)), Wi-Fi (registered trademark), Bluetooth (registered trademark), USB connection, or other exclusive lines. The device detection unit 150 grasps the presence of a device by the device being connected via the I/F unit 110.

The device detection unit 150 detects the three-dimensional position of a device based on, for example, the information sensed by the sensor apparatus 300. For example, the device detection unit 150 may extract a retroreflective material provided in the device by analyzing an infrared image captured by an infrared (IR) camera of the sensor apparatus 300, and identify the position of the device in space. Furthermore, the device detection unit 150 may extract a specific pattern (e.g., manufacturer name and two-dimensional barcode) provided in a device by analyzing a captured image captured by the camera 310 of the sensor apparatus 300, and identify the position of the device in the space.

Furthermore, the device detection unit 150 may acquire a unique ultrasonic wave transmitted from each device with the microphone 330 of the sensor apparatus 300, and identify the position of the device in the space. Furthermore, the device detection unit 150 may sense an operation of place designation performed by the user U (e.g., finger pointing, touching, line of sight, and placing marker) and a registration operation (e.g., UI selection and voice utterance) with the sensor apparatus 300, and identify the position of the device in the space.

The function of detecting information on a person, an environment, and a device in space has been described above. In the present specification, detection of each piece of information performed by the posture detection unit 120, the user detection unit 130, the environment detection unit 140, and the device detection unit 150 corresponds to space recognition, and the obtained information (result of processing of sensing environment in space) is also referred to as space information.

(Task Detection Unit)

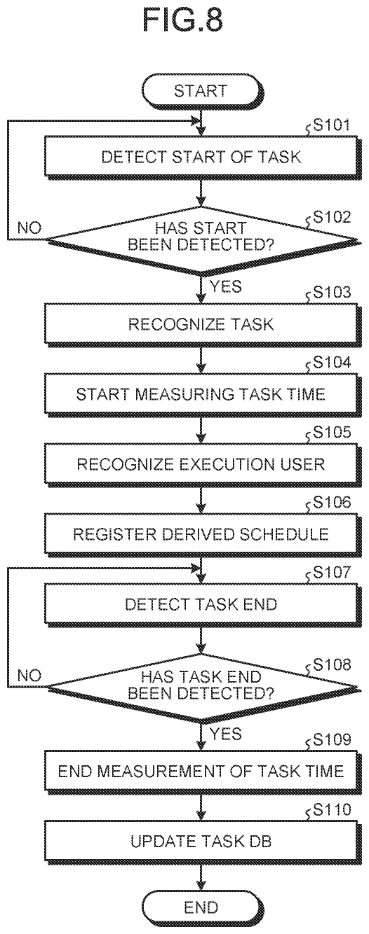

The task detection unit 171 executes task detection processing of detecting a task executed by the user U. For example, the task detection unit 171 detects a task start, recognizes a task executor, and detects a task end. Note that details of the processing performed by the task detection unit 171 will be described later with reference to FIGS. 8 to 17.

(Task Registration Unit)

The task registration unit 172 registers a task detected by the task detection unit 171 in the task DB 162. The task registration unit 172 calculates each item value of the task DB 162, such as “execution frequency”, “final execution date and time”, “required time”, and “number of times of executions (rate)”, and registers the task in the task DB 162 by updating the task DB 162. Note that the task registration unit 172 uses information on the task detected by the task detection unit 171 as information necessary for calculating each item value.

(Free Time Estimation Unit)

The free time estimation unit 173 estimates free time of the user U. The free time estimation unit 173 estimates the state of the user U based on, for example, a schedule of the user U registered in the schedule DB 161 or behavior information such as the posture or utterance of the user U. The free time estimation unit 173 may estimate whether or not the user U is in idle free time without particular task to be executed, in accordance with the estimated state of the user U. Furthermore, the free time estimation unit 173 may estimate whether or not the user U is in free time, and estimate the length of the free time in accordance with the schedule of the user U.

For example, the free time estimation unit 173 acquires the schedule of the user U from the schedule DB 161 as behavior information on the user U. When there is no schedule at the current time, the free time estimation unit 173 estimates that the user U is in free time.

Furthermore, the free time estimation unit 173 estimates the length of the free time of the user U based on a schedule that is on or after the current time. The free time estimation unit 173 estimates the time from the current time to the next schedule as the length of the free time. Note that, when the estimated length of the free time is equal to or less than a predetermined threshold, the free time estimation unit 173 may estimate that the current time is not free time. In other words, when there is no schedule from the current time to equal to or more than a predetermined threshold, the free time estimation unit 173 estimates that the user U is in the free time.

For example, the free time estimation unit 173 is estimated to confirm the next schedule of the husband at 18:45. When the schedule of the husband has no task to a “dinner” task start schedule at 19:00, the free time estimation unit 173 estimates that the husband is in free time for 15 minutes from the current time 18:45.

Alternatively, the free time estimation unit 173 may estimate free time of the user U from the posture information on the user U. In this case, the free time estimation unit 173 acquires the posture information on the user U from the posture detection unit 120 as the behavior information on the user U. When the user U has a posture of lying or leaning back, the free time estimation unit 173 estimates that the user U is in the free time. Note that the length of the free time is estimated based on the schedule of the user U.

For example, the free time estimation unit 173 is assumed to acquire posture information on the husband lying on a sofa. In this case, the free time estimation unit 173 estimates that the husband is in free time. Subsequently, the free time estimation unit 173 acquires the schedule of the husband, and estimates the length of the free time. When the schedule of the husband has nothing to a dinner start at 19:00, the free time estimation unit 173 estimates that the husband is in the free time for 15 minutes from the current time 18:45.

Furthermore, the free time estimation unit 173 may estimate the free time of the user U from the uttered voice of the user U. In this case, the free time estimation unit 173 acquires user information including uttered voice from the user detection unit 130 as behavior information on the user U. When the free time estimation unit 173 recognizes that uttered voice of the user U includes words such as “idle”, “bored”, and “There is nothing to do.”, the free time estimation unit 173 estimates that the user U is in the free time. Subsequently, the free time estimation unit 173 estimates the length of the free time based on the schedule of the user U.

For example, the free time estimation unit 173 is assumed to recognize utterance of “idle” murmured by the husband in a state of being alone in the living room L. In this case, the free time estimation unit 173 estimates that the husband is in free time. Subsequently, the free time estimation unit 173 acquires the schedule of the husband, and estimates the length of the free time. When the schedule of the husband has nothing to the dinner start at 19:00, the free time estimation unit 173 estimates that the husband is in the free time for 15 minutes from the current time 18:45.

Furthermore, the free time estimation unit 173 may estimate the free time of the user U from operation information of an external device. In this case, the free time estimation unit 173 acquires operation information on the user U from the external device via the I/F unit 110, for example. Examples of the external device include electronic devices such as the TV 220 and the smartphone 240. When the user U operates such an external device for a long time, or when the user U watches a moving image or a TV broadcast while performing zapping, the free time estimation unit 173 estimates that the user U is in the free time. Alternatively, when the user U watches content other than favorites, for example, the free time estimation unit 173 may estimate that the user U is in the free time. The free time estimation unit 173 estimates, for example, content registered as a favorite by the user, content recorded by reservation, and content frequently used (watched) as favorites. The free time estimation unit 173 may acquire information on whether or not favorite content is watched, for example, from an external device and the like.

Note that, although the free time estimation unit 173 estimates the free time of the user U from the operation information on an external device here, this is not a limitation. For example, the free time estimation unit 173 may estimate the free time from the position information on the user U and the external device. For example, when the user U and the external device are at the same place and do not move for a long time, the free time estimation unit 173 may estimate that the user U is operating the external device for a long time. The position information on the user U can be acquired from the user detection unit 130. The position information on the external device can be acquired from the device detection unit 150.

Alternatively, the external device may estimate the free time of the user U, and the free time estimation unit 173 may acquire information on the free time of the user U from the external device. Examples of a method of estimating free time with an external device in this case include an estimation method based on an operation content, operation time, and the like of the user U to the external device.

Note that the free time estimation unit 173 may estimate the free time of the user U by combining a plurality of methods of estimating free time described above. The free time estimation unit 173 may estimate whether or not the user U is in the free time based on, for example, posture information on the user U and operation information on the external device. For example, when the husband is watching the TV 220 while lying on the sofa and performing zapping, the free time estimation unit 173 estimates that the husband is in the free time. As described above, the free time estimation unit 173 estimates the free time of the user U based on a plurality of pieces of information, whereby estimation accuracy can be improved.

Furthermore, the free time estimation unit 173 estimates free time at predetermined intervals, for example. Alternatively, when there is no schedule of the user U, the free time estimation unit 173 may estimate free time. Furthermore, the free time estimation unit 173 may estimate the free time at the timing when acquiring the behavior information on the user U, for example, when recognizing uttered voice of the user U or when acquiring the posture information of the user U.

(Task Selection Unit)

The task selection unit 174 selects a task that is proposed to be executed during free time of the user U (hereinafter, also referred to as free user) whose free time has been detected. The task selection unit 174 refers to the task DB 162, and selects, for example, a task to be completed within the free time. Alternatively, the task selection unit 174 may select a task in accordance with the recommended frequency, the recommended start time, the priority, and the like.

For example, the task selection unit 174 selects a task to be completed within the free time of the user U. For example, the free time estimation unit 173 is assumed to estimate that the husband has 15 minutes of free time. In this case, the task selection unit 174 refers to the task DB 162 (see FIG. 4) of the storage unit 160, and selects a task that requires 15 minutes or less. In the example in FIG. 4, the task selection unit 174 selects the “vacuuming” task and a “bath cleaning” task. As described above, when a plurality of tasks satisfies a condition (here, “requires 15 minutes or less”), the task selection unit 174 may present all the selected tasks as candidates to the user U. Alternatively, the task selection unit 174 may select one task to be presented from a plurality of tasks by using another condition to be described later.

For example, the task selection unit 174 may select a task whose recommended start time is the closest to the current time. The recommended start time is calculated from, for example, the final execution date and time and the recommended frequency (or execution frequency) in FIG. 4.

Furthermore, the task selection unit 174 may select a task in which the difference between the recommended start time and the current time is within a threshold. When a plurality of tasks satisfies such a condition, the task selection unit 174 preferentially selects a task that is executed at the same time (or time within predetermined range) every time, for example.

Alternatively, the task selection unit 174 may select a task based on the compatibility between a task and the user U. The task selection unit 174 estimates whether or not the task and the user U have good compatibility in accordance with the number of times of task executions. For example, the task selection unit 174 selects a task having the large number (high rate) of times of executions of the user U as a task compatible with the user U.

Furthermore, the task selection unit 174 may select a task that is executed by the user U everyday (or every time) as a task compatible with the user U. Furthermore, the task selection unit 174 may calculate the number of times of executions for each category of a task, and determine a task included in a category having the large calculated number of times of executions as a task to be presented. For example, in the example in FIG. 4, the “vacuuming” task and the “bath cleaning” task are classified into a category of “cleaning”.

As described above, the task selection unit 174 can propose a task that was executed by the user U in the past or a task that the user U is good at by selecting a task based on a past task executor. This can improve motivation of the user U to execute the proposed task in free time.

Furthermore, the task selection unit 174 may select a task based on the “priority” of a task. The task selection unit 174 selects a task having a high “priority” as a task to be presented to the user U.

Furthermore, the task selection unit 174 may select a task based on “labor” required for the task. Specifically, the task selection unit 174 selects a task in accordance with the “labor” of the task DB 162 and the nature of a free user (e.g., age and sex of user). For example, the task selection unit 174 selects a task with high “labor” when the free user is an adult, and selects a task with low “labor” when the free user is a child. Furthermore, a task with high “labor” may be presented to a free user having the large number of times of executions. In this case, the task selection unit 174 selects a task with reference to, for example, “labor” and “number of times of executions (rate)” of the task DB 162. As described above, a task suitable for the nature of a free user such as age and sex can be presented by selecting a task based on the labor required for the task and the nature of the free user.

Alternatively, the task selection unit 174 may select a task based on the behavior information on the free user and the “labor” of the task. For example, when a behavior with a high load such as sports or physical labor is performed at the time before free time, or when a schedule with a high load is included in a schedule after the free time, the task selection unit 174 selects a task with low “labor”.

Furthermore, the task selection unit 174 may select a task in accordance with user information such as the age of the free user. For example, when the free user is a child, the task selection unit 174 may be set not to select a task that needs use of fire or a knife or a task having a complicated procedure, such as the “cooking” task.

Alternatively, the task selection unit 174 may select a task in accordance with the relation between a task execution place and the free user. The relation between the task execution place and the free user is whether or not the free user has a right to enter the task execution place. For example, the “son” sometimes does not want the “wife”, who is his mother, to enter the kids room R2 of his room. Alternatively, the task execution place may include a private room occupied by a resident and shared space shared by a plurality of residents. For example, a plurality of households may live in one house as in a shared house.

In this case, for example, the task selection unit 174 selects a task in accordance with the task execution place and a place that the free user can enter. For example, when the execution place of a “carrying laundry” task is a private room of a user U1, the task selection unit 174 selects the task such that the “carrying laundry” task is not presented to a user U2 who cannot enter the private room of the user U1. Furthermore, for example, although the task selection unit 174 selects the “vacuuming” task for, for example, a private room of a resident and common-use space for the resident of the shared house, the task selection unit 174 does not select the “vacuuming” task for a place other than the private room of the resident.

As described above, there may be a task that is not selected by the task selection unit 174 in accordance with a task or the user U. For example, the task selection unit 174 selects a task in accordance with age and the like, whereby the information processing apparatus 100 can present a task that can be safely performed by the user U. Furthermore, the user U who executes a task is limited depending on the task execution place, whereby the privacy of the user U can be protected.

Note that the user U who executes a task may be limited by setting the executable user U for each task, or as described above, setting a task execution place for each task. The task DB 162 stores information on the executable user U and the task execution place. Furthermore, the user U sets such information. In this case, a specific user U, for example, the user U having administrator authority may perform the setting.

The task selection unit 174 may select a task based on a surrounding situation such as a situation of another user and the time (e.g., current time) when the presented task is executed. For example, there is a case where it is better to avoid a task that makes a loud sound, such as a case where another user is sleeping, a case where another user is studying or watching TV concentratedly, and a case where the task execution time is midnight. In such a case, the task selection unit 174 does not select a task that generates sound equal to or greater than a predetermined threshold, such as a “turning on washing machine” task and the “vacuuming” task.

Specifically, the task selection unit 174 estimates the situation of another user from information on the posture and position of the other user acquired from the posture detection unit 120 and the user detection unit 130. For example, when another user sitting on the sofa is watching the TV 220 in a leaning forward system, the task selection unit 174 estimates that the other user is concentratedly watching the TV 220. Alternatively, when another user is at a desk in his/her room (e.g., when son is at desk in kids room), the task selection unit 174 may estimate that the other user is concentrating.

Furthermore, when another user is in a bed in his/her room, the task selection unit 174 may estimate that the other user is sleeping. Alternatively, the task selection unit 174 may estimate whether or not another user is sleeping in accordance with whether or not an electric light of a room which the other user is in is lit. The task selection unit 174 may estimate whether or not the electric light is lit by using an illuminance sensor, or by learning an operating time zone of an indoor electric light. Note that the user U may designate the operating time zone of the electric light. Furthermore, when the electric light is connected to a network, the task selection unit 174 may determine whether or not the electric light is lit based on a notification from the electric light.

Alternatively, the task selection unit 174 may refer to a schedule of another user to estimate a concentration time zone in which the other user concentratedly behaves and a sleeping time zone. Furthermore, the task selection unit 174 may estimate the concentration time zone and the sleeping time zone based on information acquired by a wearable terminal worn by another user.

The task selection unit 174 selects a task whose noise level is equal to or less than a threshold in accordance with the estimated situation of another user or the task execution time. The threshold of the noise level at this time is set in accordance with the place which another user is in and the task execution place. Even when a task generates a loud sound, when the task execution place is away from a place which another user is in, the sound heard by the other user is decreased, and may fail to disturb the situation of the other user. Therefore, a noise level threshold is set for, for example, each room in accordance with the task execution place. The task selection unit 174 selects a task in accordance with the set noise level threshold.

Note that the noise level threshold is set, for example, when a task is executed, by measuring noise generated at the time of task execution with the microphone 330 installed in each room. Furthermore, for example, the task DB 162 records the noise level threshold.

Furthermore, the task selection unit 174 may select a task in accordance with the number of free users and the number of people necessary for task execution. The task selection unit 174 selects a task in which the number of people necessary for execution is equal to or smaller than the number of free users.

Furthermore, when selecting a task in which the number of people necessary for execution is less than the number of free users, the task selection unit 174 determines to which free user the selected task is to be presented based on the compatibility between the free user and the selected task, labor of the task, and the like.

Alternatively, the task selection unit 174 determines a free user to whom the selected task is to be presented in accordance with a task that can be proposed to the remaining free users when the selected task is allocated to the specific free user. For example, the task selection unit 174 determines a task to be presented to a free user in order from a task having a small number of free users capable of executing the selected task. As a result, the information processing apparatus 100 can present a task to more free users.

Furthermore, when there is another user U who is executing a task (hereinafter, also referred to as another-task executing user), a task to be presented to a free user may be selected in accordance with the task being executed by the another-task executing user.

For example, it is assumed that, when the wife is executing the “cooking” task, the free time estimation unit 173 estimates the free time of the “husband”. In this case, the task selection unit 174 acquires information on the task being executed by the “wife” from the task detection unit 171, and selects a task to be presented to the husband based on the acquired information. For example, the free time estimation unit 173 selects a task related to the “cooking” task, such as a “cleaning up dining table” task and an “arranging dishes and preparing meal” task as a task to be presented to the “husband”.

Alternatively, the task selection unit 174 may select the task to be presented to the “husband” as information on the task to be executed by the “wife” based on the scheduled task end time. For example, when the “cooking” task of the “wife” is scheduled to end at 19:00, the task selection unit 174 selects a task that can be completed by 19:00 as the task to be presented to the “husband”.

Specifically, when the task detection unit 171 detects the “cooking” task of the “wife”, “starting dinner” is stored in the schedule DB 161 as a derived schedule. The free time estimation unit 173 refers to the schedule DB 161 to estimate a period until the derived schedule is started as free time. The task selection unit 174 selects a task based on the free time estimated as described above. The task selection unit 174 can thereby select the task to be presented to the “husband” as information on the task executed by the “wife” based on the scheduled task end time. Note that the derived schedule will be described later with reference to FIG. 8.

Alternatively, the task selection unit 174 may select a task to be presented to a free user in response to a request from another-task executing user. For example, when the another-task executing user has difficulty in executing a task and requests help, the task executed by the another-task executing user is selected as a task to be presented. Note that whether or not the another-task executing user requests help is detected based on, for example, voice data of the another-task executing user. Alternatively, the another-task executing user notifies the information processing apparatus 100 that the another-task executing user wants help, whereby the information processing apparatus 100 detects the request. For example, the notification for help may be given by, for example, a gesture or input from an apparatus including an input apparatus such as the smartphone 240.

(Output Control Unit)

Returning to FIG. 2, the output control unit 175 controls the operation of the output apparatus 200 via the I/F unit 110. The output control unit 175 presents information on a task selected by the task selection unit 174 (hereinafter, also referred to as task information) to a free user via the output apparatus 200.

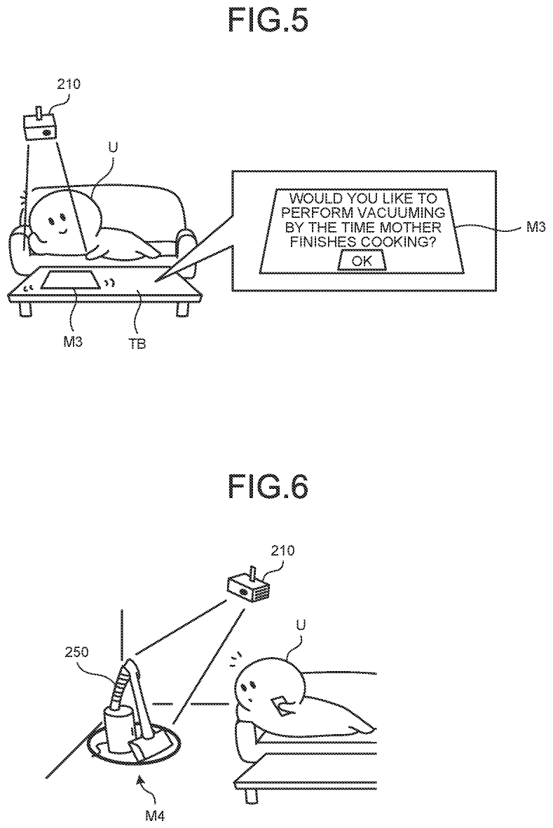

A method of presenting task information performed by the output control unit 175 will be described with reference to FIG. 5. FIG. 5 illustrates presentation of task information performed by the output control unit 175.

As illustrated in FIG. 5, the output control unit 175 presents the task information to the user U by controlling the moving projector 210 and projecting an image M3. For example, the output control unit 175 causes the moving projector 210 to project an image M3 including a sentence “Would you like to perform vacuuming by the time Mother finishes cooking?” on a table TB in front of the line of sight of the user U as task information.

Note that, although, an “OK” button is displayed together with the text in FIG. 5, the content included in the image M3 is not limited to a sentence or the “OK” button. For example, the output control unit 175 may present an option of rejecting the execution of the presented task, such as “later” and “no” to the User U in addition to the “OK” button. For example, when “later” is selected, the output control unit 175 may present the task information presented this time to the user U after a predetermined time elapses or at the next free time.

Furthermore, when “No” is selected, the output control unit 175 may acquire a reason why the user U does not want to execute a task from the user U, and present a new task in accordance with the acquired reason to the user U. Specifically, for example, the output control unit 175 lists several reasons why the user U does not want to execute a task, such as “tired”, “not favorite household task”, and “not idle”, and causes the user U to select a reason. The task selection unit 174 newly selects a task that does not correspond to the reason selected by the user U. For example, when the user U selects “tired”, the task selection unit 174 selects a simple task having a “strength” lower than that of the task presented to the user U. Furthermore, for example, when the user U selects “not favorite household task”, the task registration unit 172 may register that the User U dislikes the presented task in the task DB 162.

Furthermore, the image projected by the output control unit 175 on the moving projector 210 is not limited to that including a sentence. The image may include an illustration, a photograph, and the like. Alternatively, when an article used for a task such as the vacuum cleaner 250 in FIG. 6 is located in the same room as the user U, the moving projector 210 may project a GUIM 4 for highlights such as light and an image on the article so that the article is emphasized (highlighted). In this case, the moving projector 210 may project highlights in accordance with the priority and urgency of a task presented by the output control unit 175. Note that FIG. 6 is a view (1) illustrating another example of task information presentation performed by the output control unit 175.

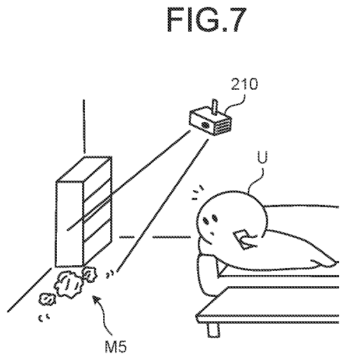

Furthermore, the output control unit 175 may not only present information directly related to a task but indirectly present the task to the user U by, for example, displaying an illustration related to the task. For example, as illustrated in FIG. 7, the output control unit 175 may project an illustration M5 of dust on a recessed position where dust is easily to be accumulated or a position where normal vacuuming takes time via the moving projector 210. In this case, the output control unit 175 moves and displays the illustration M5 to draw attention of the user U. Note that note that FIG. 7 is a view (2) illustrating another example of task information presentation performed by the output control unit 175.

Note that the output apparatus 200 used by the output control unit 175 to present the task information is not limited to the moving projector 210. For example, the image M3 may be displayed on a display of an apparatus including the display, such as the TV 220 and the smartphone 240. Alternatively, the output control unit 175 may cause the speaker 260 to output voice reading out a sentence.

Furthermore, for example, when presenting the “vacuuming” task that uses the vacuum cleaner 250 connected to a network, the output control unit 175 can control the operation of an article (here, vacuum cleaner 250) used for the task. In this case, the output control unit 175 may present the task information with an apparatus related to the task. For example, the output control unit 175 may generate alarm sound from the article used for the task. Even when the article used for the task is not connected to the network, the output control unit 175 may output sound generated from the article by using, for example, a directional speaker.

Furthermore, the output control unit 175 presents guidance information for guiding the user U to execute a task. The guidance information may be presented to the user U as one of the task information. For example, the output control unit 175 may present an arrow indicating the route to the place of the vacuum cleaner 250 together with a sentence “Would you perform vacuuming?” as the guidance information.

Furthermore, the guidance information may be presented when it is detected that a free user executes a presented task. For example, when the task execution is detected by the free user selecting an “OK” button (see FIG. 5) of the presented image M3, the output control unit 175 presents the guidance information by projecting an arrow to the place where the vacuum cleaner 250 is located. Alternatively, the output control unit 175 may project the guidance information when detecting that the free user has stood up.

Furthermore, when detecting task start from the operation of the user U turning on the vacuum cleaner 250, the output control unit 175 may guide the user U to the place or order to be vacuumed with the vacuum cleaner 250 by, for example, projecting an illustration of dust. The task DB 162 stores, for example, the same past task execution place and procedure. The guidance information including a task execution place and a procedure are generated based on the stored execution place and procedure. Note that the output control unit 175 may present a place which the user U usually does not vacuum with the vacuum cleaner 250, such as a place under a sofa, as the guidance information with reference to, for example, the room layout of the house and the position of the furniture.

Furthermore, when a task is interrupted halfway last time, the output control unit 175 may present the guidance information so that the task can be resumed from where the task was interrupted. For example, if the “wife” has interrupted the “vacuuming” task after vacuuming the living room L and the dining room D with the vacuum cleaner 250, the output control unit 175 displays the guidance information so that the “husband” of a free user vacuums the kitchen K with the vacuum cleaner 250. The output control unit 175 may guide the “husband” to the kitchen K by using an arrow, or by using a sentence and voice, for example. Alternatively, the output control unit 175 may display the room layout of the house, and present a place which has not been vacuumed with the vacuum cleaner 250 to the “husband”.

Note that, since the moving projector 210 is installed on the ceiling of the living room L, an image cannot be projected with the moving projector 210 at a place away from the living room L, such as a corridor and the kids room R2. In such a case, there is a case where the user U is desired to be guided to the outside of the projection range of the moving projector 210. For example, there is a case where the user U is desired to be guided to the kids room R2 as a room to be vacuumed next with the vacuum cleaner 250. In this case, for example, the output control unit 175 displays an arrow toward a doorway connected to the corridor of the living room L.

As described above, when a task execution place (kids room R2) is located outside the presentation (projection) range of a presentation device (here, moving projector 210) that presents the task, guidance information for guiding the user U to a route within the presentation (projection) range among routes to the task execution place (kids room R2) (arrow toward doorway connected to corridor of living room L) is generated. This allows the moving projector 210 to guide the user U to the task execution place even when the task execution place is located outside the presentation range.

For example, when the user U arrives at the doorway, the output control unit 175 guides the user U to the kids room R2 by causing the speaker 260 installed in the kids room R2 to output alarm sound, vacuuming sound of the vacuum cleaner 250, and the like. As described above, when the user U moves to the outside of the projection range of the moving projector 210, the output control unit 175 presents the guidance information with the output apparatus 200 (here, speaker 260) different from the moving projector 210.

As described above, when the user U moves to the outside of the presentation (projection) range, the guidance information is presented to the user U with a device (here, speaker 260) different from the presentation (projection) device. This allows the user U to be guided to the task execution place even when the user U moves to the outside of the presentation (projection) range.

Note that, although the guidance information is presented to the user U by the moving projector 210 projecting the guidance information here, this is not a limitation. For example, the guidance information may be presented by, for example, the moving projector 210 outputting voice. Alternatively, the guidance information may be presented to the user U by displaying an image on a display of an apparatus including the display, such as the TV 220 and the smartphone 240. In this case, examples of the image to be displayed on the display include a map including a route to a task execution place, a sentence and an arrow indicating the task execution place, and the like.

Furthermore, the output apparatus 200 that presents guidance information outside the projection range of the moving projector 210 is not limited to the speaker 260, and may be, for example, a PC and the smartphone 240 installed in the kids room R2.

Furthermore, when a free user starts executing a task, the output control unit 175 notifies another-task executing user who executes another task of the task execution. For example, when the “husband” starts the “vacuuming” task, the output control unit 175 notifies the “wife” who is cooking by projecting a sentence “Father has started vacuuming”.

The output control unit 175 may notify another user of the progress level of the task being executed by the user. For example, when the “husband” finishes vacuuming the living room L and the dining room D with the vacuum cleaner 250 and moves to the kids room R2, the output control unit 175 notifies the “wife” who is cooking by projecting a sentence “Cleaning of living room and dining room is finished, and next is turn of kids room”. As described above, another user is notified of the progress level of a task, whereby the other user can behave in accordance with the progress of the task. For example, the “wife” who has received the notification can determine that it will take more time to complete the “vacuuming” task, and create another dish. Furthermore, when the cooking is likely to end early, the “wife” can help the “husband” performing the “vacuuming” task. For example, the “wife” can clean up the main bedroom R1 that has not been vacuumed with the vacuum cleaner 250.

The output control unit 175 may notify another user of, for example, completion, interruption, or the like of a task in addition to the start and progress level of the task. For example, a notification of the interruption of a task allows determination of whether or not to continue the task interrupted by another user. For example, a notification of the “husband” interrupting the “vacuuming” task is given, whereby the “wife” who is cooking may determine to perform vacuuming with the vacuum cleaner 250 after a meal. The “vacuuming” task can be registered in the schedule of the “wife”. Furthermore, when the “vacuuming” task is registered in the schedule of the “wife”, the task can be deleted by notification of task completion, and the “wife” can express her appreciation to the “husband”.

Note that the output control unit 175 may output various pieces of information other than the above-described task information, guidance information, and notification of a task.

[1-3. Procedure of Information Processing According to Embodiment]

Subsequently, information processing performed by the information processing system according to the present embodiment will be specifically described with reference to the drawings.

(Task Registration Processing)

First, task registration processing will be described with reference to FIG. 8. FIG. 8 is a flowchart illustrating a procedure of task registration processing according to the embodiment of the present disclosure. The task detection unit 171 and the task registration unit 172 of the information processing apparatus 100 in FIG. 2 execute the task registration processing.

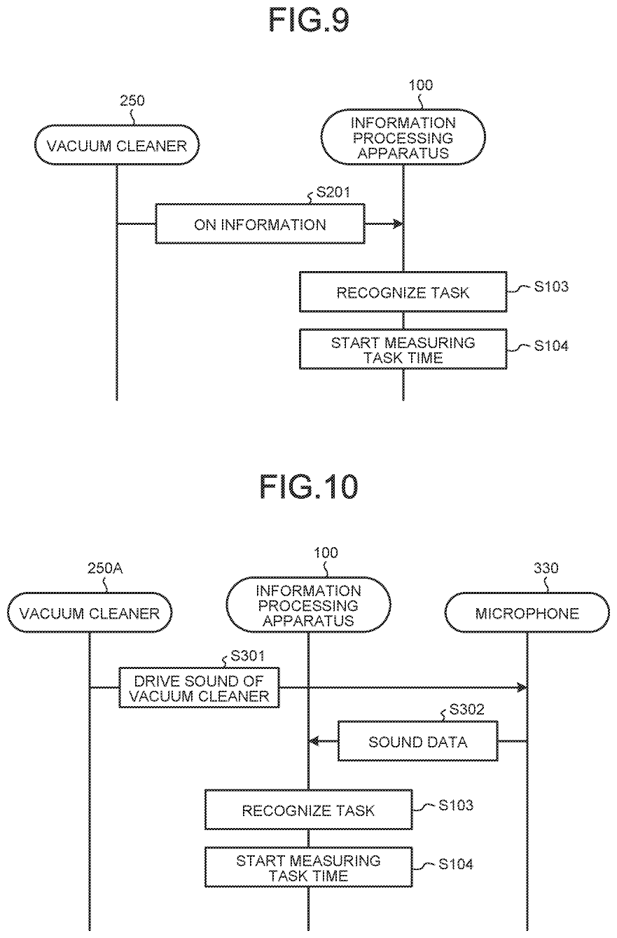

As illustrated in FIG. 8, the task detection unit 171 detects the start of a task (Step S101). Note that, detection of the task start will be described later with reference to FIG. 9. Next, the task detection unit 171 determines whether or not the start of the task has been detected (Step S102). When the start of the task has not been detected (Step S102; No), the processing returns to Step S101.

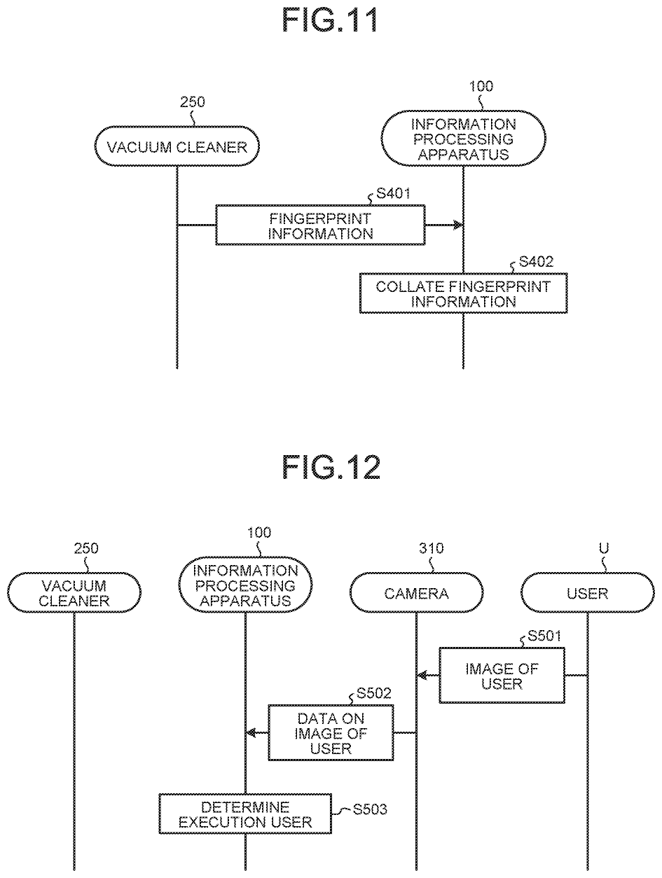

In contrast, when the start of the task is detected (Step S102; Yes), the task detection unit 171 recognizes the task (Step S103), and starts measuring task time (Step S104). Subsequently, the task detection unit 171 recognizes a user who is executing the task (hereinafter, also referred to as execution user) (Step S105). Recognition of the execution user will be described later with reference to FIG. 11.

The task registration unit 172 registers a derived schedule derived by execution of the task in the schedule DB 161 based on the task recognized by the task detection unit 171 (Step S106). For example, when the task detection unit 171 recognizes that the “wife” is executing a “cooking” task, the task registration unit 172 estimates an end time of the task.

The end time of the task is estimated from, for example, the cooking time of a recipe being referred to, the past task execution time, and the like. Note that the recipe may be acquired from a recipe site via the Internet or the like, or may be acquired from an electric cooking appliance connected to a network, for example. The task registration unit 172 registers a derived schedule of “dinner” related to the task as a schedule of the users U including the “husband” and the “son” on the assumption that the derived schedule is started from the end time of the task.

For example, the “wife” starts the “cooking” task at 18:00, and the task registration unit 172 is assumed to estimate, from a recipe, that the task ends at 19:00. In this case, the task registration unit 172 registers the derived schedule in which the “dinner” of the users U including of the “husband” and the “son” is “started at 19:00” at the “dining room” and “ends at 20:00”.

As described above, a target for which a derived schedule is registered is not limited to an execution user who is executing a task, and may include the user U who is not executing the task. Furthermore, the derived schedule may include a derived task derived by execution of the task. For example, when a “turning on washing machine” task is executed, a “drying laundry” task is registered as a derived task.

Note that, when there is no derived schedule of the task recognized in Step S103, the processing in Step S106 can be omitted.

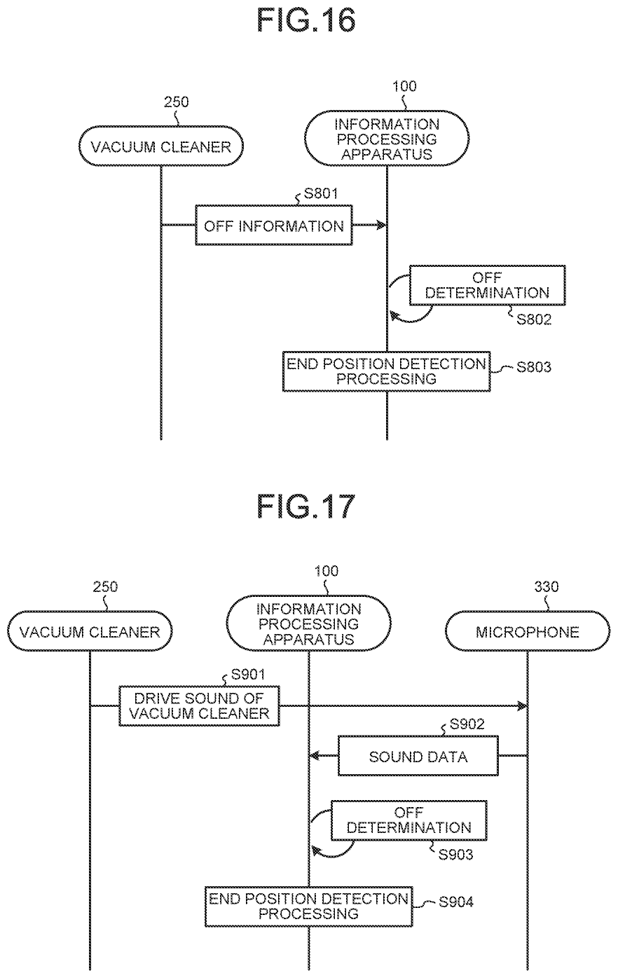

Subsequently, the task detection unit 171 detects the task end (Step S107). The detection of the task end will be described later with reference to FIG. 16. Next, the task detection unit 171 determines whether or not the task end has been detected (Step S108). When the task end has not been detected (Step S108; No), the processing returns to Step S107.

In contrast, when the task end is detected (Step S108; Yes), the task detection unit 171 ends the measurement of the task time (Step S109). The task registration unit 172 updates the task DB 162 based on a result detected by the task detection unit 171 (Step S110), and ends the processing. As a result, the task executed by the execution user is registered in the task DB 162.

Note that the task registration unit 172 updates the number of times of executions of the recognized task based on the recognition result of the task. Furthermore, the task registration unit 172 updates the required time of the task DB 162 based on, for example, the task time measured by the task detection unit 171. Furthermore, the task registration unit 172 updates the task DB 162 with the date and time when the task end is detected as the final execution date and time. Furthermore, the task registration unit 172 updates the number of times of executions of each user U based on the execution user recognized by the task detection unit 171.

(Detection of Task Start)

Next, detection of task start will be described with reference to FIG. 9. FIG. 9 is a sequence diagram illustrating the detection of task start.

For example, when the user U starts the “vacuuming” task, the user U turns on the vacuum cleaner 250. When turned on, the vacuum cleaner 250 notifies the information processing apparatus 100 of ON information (Step S201). As described above, the information processing apparatus 100 can detect the start of the task by receiving the ON information from the vacuum cleaner 250.

The information processing apparatus that has detected the start of the task recognizes a task executed by the user based on which apparatus has given a notification of the ON information (Step S103). In FIG. 9, since the vacuum cleaner 250 has given a notification of the ON information, the information processing apparatus 100 recognizes the start of the “vacuuming” task. The information processing apparatus 100 starts measuring the task time of the recognized task (Step S104), and continues to execute the task registration processing in FIG. 8.

Note that, although a case where an apparatus used for a task (here, vacuum cleaner 250) is connected to the information processing apparatus 100 via, for example, a network has been described in FIG. 9, the apparatus used for a task is not necessarily connected to the information processing apparatus 100. Therefore, a case where the start of a task is detected by using an apparatus that is not connected to the information processing apparatus 100 will be described with reference to FIG. 10 by taking a vacuum cleaner 250A as an example. FIG. 10 is a sequence diagram illustrating another example of the detection of task start.

As illustrated in FIG. 10, when the user U starts the “vacuuming” task, a drive sound is generated by turning on the vacuum cleaner 250A, and the microphone 330 detects the drive sound (Step S301). The microphone 330 notifies the information processing apparatus 100 of sound data of the detected drive sound (Step S302). The information processing apparatus 100 detects the start of the task by recognizing that the sound data received from the microphone 330 is drive sound of the vacuum cleaner 250A, and recognizes that the detected task is “vacuuming” (Step S103). The information processing apparatus 100 starts measuring the task time of the recognized task (Step S104), and continues to execute the task registration processing in FIG. 8.

As described above, the information processing apparatus 100 can detect the task using an apparatus that is not connected to the network by detecting the start of the task based on the sound data detected by the microphone 330. Note that the data used by the information processing apparatus 100 to detect the start of a task is not limited to the sound data detected by the microphone 330. For example, the information processing apparatus 100 may detect or recognize the start of a task in accordance with a detection result of the sensor apparatus 300, such as a captured image of the camera 310 and a depth map of the depth sensor 320. Furthermore, the information processing apparatus 100 detects or recognizes the start of a task by using detection results of a plurality of apparatuses, whereby the detection accuracy and the recognition accuracy can be improved.

Note that, when detecting the start of a task, the information processing apparatus 100 may control the sensor apparatus 300 so as to increase the detection accuracy of each apparatus. For example, the information processing apparatus 100 may set a high reception sensitivity of the microphone 330, or may set a high resolution of the camera 310.

As a result, the detection accuracy of each apparatus after the detection of the task start can be improved. The accuracy of processing (e.g., recognition of execution user and detection of task end), using a detection result of each apparatus, performed by the information processing apparatus 100 can be improved.

(Recognition of Execution User)

Subsequently, recognition of an execution user performed by the task detection unit 171 will be described with reference to FIG. 11. FIG. 11 is a sequence diagram illustrating the recognition of an execution user. Such recognition of an execution user is processing executed in Step S105 in FIG. 8.

For example, a power button of the vacuum cleaner 250 is assumed to be mounted with, for example, a fingerprint recognition sensor for recognizing an execution user. In this case, for example, the vacuum cleaner 250 notifies the information processing apparatus 100 of fingerprint information on the user U who has turned on the vacuum cleaner 250 (Step S401). For example, the information processing apparatus 100 collates the fingerprint information on the user U stored in the storage unit 160 with the fingerprint information received from the vacuum cleaner 250 (Step S402), and recognizes the execution user of a task.

Note that, although the information processing apparatus 100 collates the fingerprint information on the user U here, the vacuum cleaner 250 may collate the fingerprint information, and give a notification of the information on the execution user, for example.

Next, a case where the execution user is recognized by using the vacuum cleaner 250A that is not connected to the information processing apparatus 100 will be described with reference to FIG. 12. FIG. 12 is a sequence diagram illustrating another example of the recognition of an execution user.

When the start of the “vacuuming” task is detected, the camera 310 captures an image of the user U (Step S501). The camera 310 transmits data on the captured image to the information processing apparatus 100 (Step S502). The information processing apparatus 100 determines the execution user from the acquired image data (Step S503). Specifically, the information processing apparatus 100 detects the vacuum cleaner 250A to be used for the task by, for example, template matching or the like, and detects a user near the detected vacuum cleaner 250A. The information processing apparatus 100 recognizes the detected user U as an execution user.

Note that the data used by the information processing apparatus 100 to detect the start of the task is not limited to the data of the image captured by the camera 310. For example, the information processing apparatus 100 may recognize the execution user in accordance with a detection result of the sensor apparatus 300, such as a depth map of the depth sensor 320 and voice data of the microphone 330. Furthermore, the information processing apparatus 100 recognizes the execution user by using detection results of a plurality of apparatuses, whereby the recognition accuracy can be improved.

Furthermore, the information processing apparatus 100 may recognize the execution user by, for example, detecting a processing procedure of a task. For example, in the case of the “vacuuming” task, the information processing apparatus 100 stores a processing procedure of a past task, such as an order of rooms vacuumed with the vacuum cleaner 250 and a place where vacuuming is started with the vacuum cleaner 250 in each room. When detecting the start of the “vacuuming” task, the information processing apparatus 100 detects a processing procedure of the “vacuuming” task, and compares the processing procedure with a past processing procedure. The information processing apparatus 100 recognizes an execution user of the task in accordance with the comparison result.

As described above, the information processing apparatus 100 can recognize the execution user by various methods including the above-described example, for example. The various methods may be executed alone or by combining a plurality of methods. The information processing apparatus 100 recognizes an execution user by combining a plurality of methods, whereby the recognition accuracy can be improved.

Even if the information processing apparatus 100 recognizes the execution user by, for example, the above-described method, however, the recognition result may have low reliability. For example, when the execution user is recognized based on processing procedures, the small number of accumulated processing procedures reduces the reliability of the recognition result. As described above, when a recognition result of the information processing apparatus 100 has low reliability, the information processing apparatus 100 presents the recognition result to the user U and receives correction from the user U, for example. The information processing apparatus 100 thereby recognizes a correct execution user.

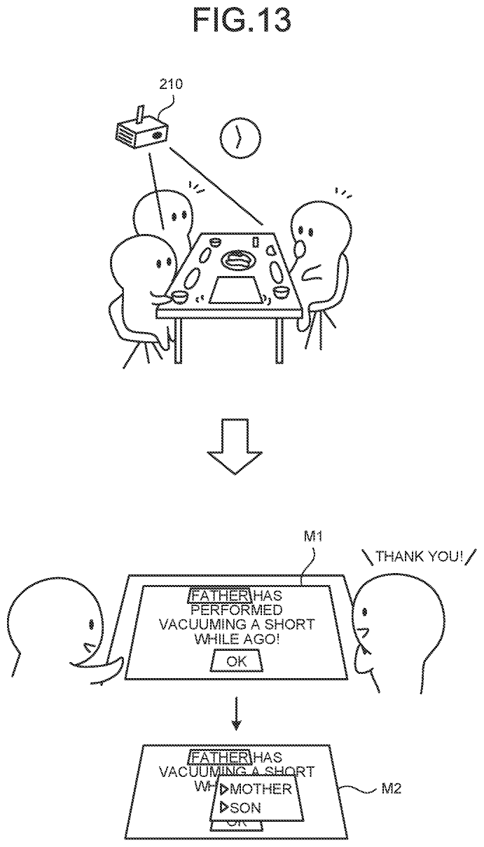

For example, when a result of recognizing an execution user has low reliability, the information processing apparatus 100 presents information including the recognition result to the user U as illustrated in FIG. 13 after completing the detected task. FIG. 13 illustrates correction of a result of recognizing an execution user. Here, a case where the information processing apparatus 100 recognizes that the “husband” has executed the “vacuuming” task will be described. Furthermore, it is assumed that a schedule of “dinner” is executed after the “vacuuming” task.

As illustrated in FIG. 13, the information processing apparatus 100 presents information including a result of recognizing an execution user (hereinafter, user recognition information) at a place (e.g., dining table) which can be visually recognized by the users U (family) during a meal. In the example of FIG. 13, for example, the information processing apparatus 100 projects an image M1 including a sentence “Father has performed vacuuming a short while ago!” by using the moving projector 210. As described above, the user U who has not executed a task can be notified of an execution user by user recognition information presented at a place which a plurality of users U is at, whereby the other users can express their appreciation to the execution user.

Furthermore, for example, as illustrated in an image M2 of FIG. 13, another user can be selected by a pull-down menu at a position indicating execution users. As a result, when the recognition result of the information processing apparatus 100 is wrong, the user U can correct the execution user by selecting an execution user from the pull-down menu. Note that, although FIG. 13 illustrates a case where the user U can correct an execution user, the user U may also be able to correct the type of a task.

(Position Detection Processing)

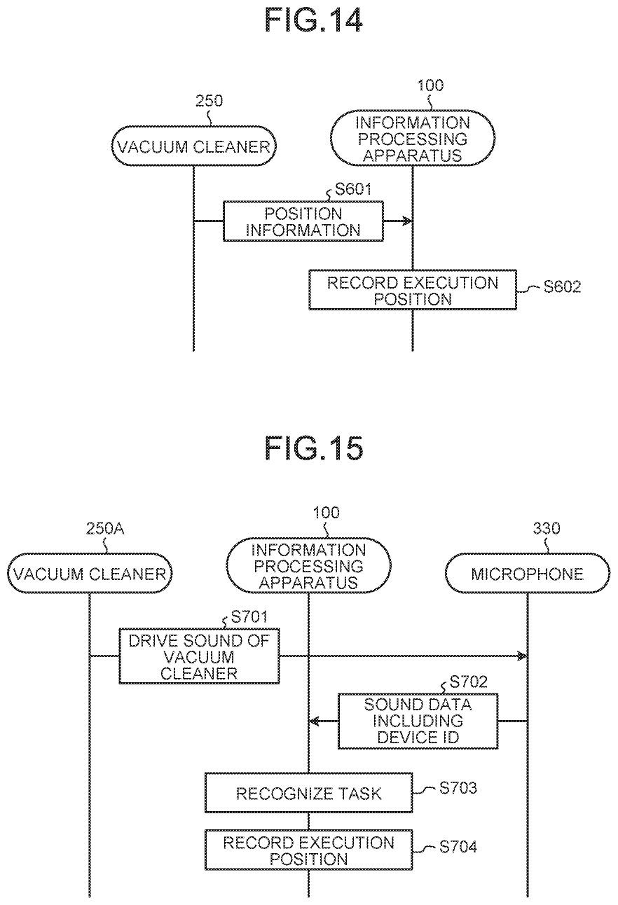

As described above, the information processing apparatus 100 may detect information on a procedure of a task, such as a task execution place. Here, position detection processing in which the information processing apparatus 100 detects a task execution place will be described with reference to FIG. 14. FIG. 14 is a flowchart illustrating the position detection processing. Such position detection processing is assumed to be executed at predetermined intervals from when the information processing apparatus 100 detects the start of a task to when the information processing apparatus 100 detects the end of the task.

As illustrated in FIG. 14, the information processing apparatus 100 receives a notification of the position information from the vacuum cleaner 250 (Step S601). For example, the vacuum cleaner 250 may acquire the position information from the radio field strength of a signal transmitted from an access point of the wireless LAN, and may acquire the position information by using an indoor GPS. Furthermore, the vacuum cleaner 250 may acquire the position information by detecting an IC tag arranged in the house.

The information processing apparatus 100 that has received the position information from the vacuum cleaner 250 records the received position information as the position of the vacuum cleaner 250 in, for example, the task DB 162 (Step S602).

Next, position detection processing of detecting the position of the vacuum cleaner 250A that is not connected to the information processing apparatus 100 will be described with reference to FIG. 15. FIG. 15 is a sequence diagram illustrating another example of the position detection processing. Note that the microphone 330 is assumed to be installed in each room.

When the user U uses the vacuum cleaner 250A, a drive sound of the vacuum cleaner 250A is generated, and the microphone 330 in the room being vacuumed with the vacuum cleaner 250A detects the drive sound (Step S701). When detecting the drive sound, the microphone 330 transmits sound data including a device ID of the microphone 330 itself to the information processing apparatus 100 (Step S702).

When receiving the sound data from the microphone 330, the information processing apparatus 100 recognizes a task from the received sound data (Step S703). When the recognized task is “vacuuming”, the information processing apparatus 100 records a room in which the microphone 330 corresponding to the device ID is installed as a task execution position (Step S704).

Note that, when a plurality of microphones 330 detects the drive sound, the information processing apparatus 100 sets, for example, a room in which the microphone 330 that has detected the largest sound is installed as the task execution position based on the loudness of the sound detected by the microphone 330.

Furthermore, the data used by the information processing apparatus 100 to detect the task execution position is not limited to the sound data detected by the microphone 330. For example, the information processing apparatus 100 may detect the task execution position in accordance with a detection result of the sensor apparatus 300, such as a captured image of the camera 310 and a depth map of the depth sensor 320. Furthermore, the information processing apparatus 100 detects the task execution position by using detection results of a plurality of apparatuses, whereby the detection accuracy can be improved.

(Detection of Task End)

Next, detection of task end will be described with reference to FIG. 16. FIG. 16 is a sequence diagram illustrating the detection of task end. Such detection of the task end is processing executed in Step S107 in FIG. 8.

For example, when the user U ends the “vacuuming” task, the user U turns off the vacuum cleaner 250. When turned off, the vacuum cleaner 250 notifies the information processing apparatus 100 of OFF information (Step S801).

The information processing apparatus 100 that has received the notification performs OFF determination of the vacuum cleaner 250 for a predetermined period (Step S802). The information processing apparatus 100 performs the OFF determination of the vacuum cleaner 250 by repeatedly determining whether or not the information processing apparatus 100 has received a notification of the ON information from the vacuum cleaner 250 for a predetermined period. For example, when the user U moves a room to be vacuumed with the vacuum cleaner 250, the user U may once turn off the vacuum cleaner 250, move to the next room, and turn on the vacuum cleaner 250 again. Even in such a case, the task end can be detected without mixing up a case where the user U temporarily interrupts the task with the task end by the information processing apparatus 100 performing the OFF determination of the vacuum cleaner 250 for a predetermined period.

In Step S802, the information processing apparatus 100 that has detected OFF of the vacuum cleaner 250, that is, the task end ends the position detection processing in FIG. 14 (Step S803), and continues to execute the task registration processing in FIG. 8.

Next, a case where the task end is detected by using the vacuum cleaner 250A that is not connected to the information processing apparatus 100 will be described with reference to FIG. 17. FIG. 17 is a sequence diagram illustrating another example of the detection of the task end.

As illustrated in FIG. 17, while the user U is executing the “vacuuming” task, drive sound of the vacuum cleaner 250A is generated, and the microphone 330 detects the drive sound (Step S901). The microphone 330 notifies the information processing apparatus 100 of sound data of the detected drive sound (Step S902).

When detecting the task start, the information processing apparatus 100 repeatedly executes the OFF determination (Step S903). When not receiving the sound data of the vacuum cleaner 250 from the microphone 330 for a certain period, the information processing apparatus 100 determines that the vacuum cleaner 250A has been turned off, and the task has ended.

When determining that the task has ended, the information processing apparatus 100 ends the position detection processing in FIG. 15 (Step S904), and continues to execute the task registration processing in FIG. 8.

Note that, when detecting the task end, the information processing apparatus 100 returns parameters of the sensor apparatus 300, such as the reception sensitivity and the resolution, to the original values. The parameters have been set so as to increase the detection accuracy of the sensor apparatus 300. As described above, the parameters of the sensor apparatus 300 are reduced after the task end. Unnecessary power consumption of the sensor apparatus 300 can thus be reduced. A mental burden of being constantly sensed of the user U can also be reduced.

(Specific Example of Task Registration Processing)

Here, for example, task registration processing executed by the information processing apparatus 100 at the time when the “husband” executes the “vacuuming” task in the living room L, the main bedroom R1, and a dressing room will be described. Note that, the description will be given here by using an example of a case where the vacuum cleaner 250A is not connected to a network.

First, when the “husband” turns on the vacuum cleaner 250A in the living room L, the camera 310 installed in the living room L transmits a captured image including the vacuum cleaner 250A and the “husband” to the information processing apparatus 100. Furthermore, the microphone 330 installed in the living room L notifies the information processing apparatus 100 of sound data including drive sound of the vacuum cleaner 250A.

The information processing apparatus 100 detects that the “husband” has started the “vacuuming” task in the “living room” at “18:45 on Mar. 1, 2019” based on the data from the camera 310 and the microphone 330.

When the “husband” moves from the living room L to the main bedroom R1, the microphone 330 installed in the main bedroom R1 detects the drive sound of the vacuum cleaner 250A, and notifies the information processing apparatus 100. The information processing apparatus 100 detects that the “husband” has started the “vacuuming” task in the “main bedroom” at “18:50 on Mar. 1, 2019” based on the notification. At this point, the information processing apparatus 100 determines that the “husband” is highly likely to have started the “vacuuming” task from “18:45 on Mar. 1, 2019”, for example.

Next, when the “husband” moves from the main bedroom R1 to the dressing room, the information processing apparatus 100 cannot directly acquire information from the sensor apparatuses 300 such as the camera 310 and the microphone 330 since these sensor apparatuses 300 are not installed in the dressing room. Therefore, the information processing apparatus 100 detects that the “husband” has started the “vacuuming” task in the “dressing room” at “18:53 on Mar. 1, 2019” based on detection results of, for example, the camera 310 installed in the corridor and the microphone 330 installed in the main bedroom R1.

When the vacuum cleaner 250A is turned off in the dressing room, for example, the detection of drive sound performed by the microphone 330 installed in the main bedroom R1 is stopped. When the drive sound is not detected for a predetermined time, the information processing apparatus 100 detects that the “husband” ends the “vacuuming” task at the “dressing room” at “18:55 on Mar. 1, 2019” when the detection of drive sound is stopped.

The information processing apparatus 100 stores the type of the detected task (vacuuming), the recognized execution user (husband), the required time (10 minutes), and the final execution date and time (18:55 on Mar. 1, 2019) in the storage unit 160 based on the detection results so far. Furthermore, the information processing apparatus 100 updates the execution frequency of the task.

(Task Presentation Processing)

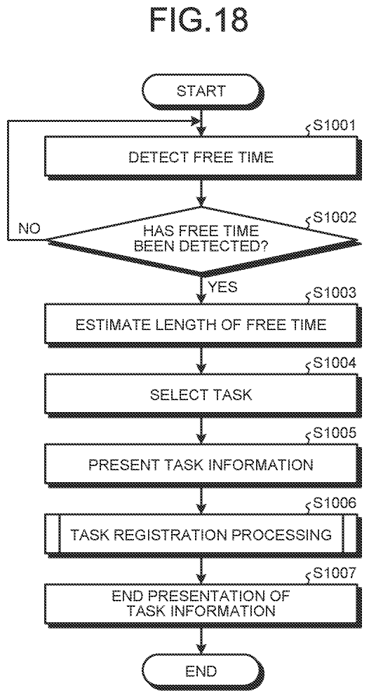

Subsequently, task presentation processing will be described with reference to FIG. 18. FIG. 18 is a flowchart illustrating a procedure of task presentation processing according to the embodiment of the present disclosure.

As illustrated in FIG. 18, the information processing apparatus 100 detects free time (Step S1001). When the information processing apparatus 100 does not detect free time (Step S1002; No), the processing returns to Step S1001. In contrast, when detecting the free time (Step S1002; Yes), the information processing apparatus 100 estimates the length of the detected free time (Step S1003). The information processing apparatus 100 estimates the length of the free time based on, for example, the current time at which the free time has been detected and the next schedule registered in a schedule.

Subsequently, the information processing apparatus 100 selects a task to be presented to a free user with reference to the task DB 162 (Step S1004). The information processing apparatus 100 presents task information to the free user (Step S1005). Note that the task information presented by the information processing apparatus 100 may include guidance information for executing the selected task in addition to the information on the selected task.

When the free user has executed the presented task, the information processing apparatus 100 executes task registration processing (see FIG. 8) (Step S1006). When the task registration processing ends, that is, when the task is completed, the information processing apparatus 100 ends the presentation of the task information (Step S1007), and ends the processing.

(Specific Example of Task Presentation Processing)

Here, a specific example of task presentation processing performed by the information processing apparatus 100 will be described. Here, it is assumed that the “husband” lies on the sofa in living room L and is watching a favorite TV program on the TV 220, and the “wife” is making dinner in the kitchen K. Furthermore, the “son” is assumed to wait for completion of cooking while loosely operating the smartphone 240 for nothing in the kids room R2.

At this time, the information processing apparatus 100 detects the “cooking” task performed by the “wife” at 18:00. The information processing apparatus 100 registers “dinner” from 19:00 in the schedule DB 161 as a derived schedule of the detected task.

Furthermore, the information processing apparatus 100 is assumed to have detected free time of the “son” at 18:45. The information processing apparatus 100 calculates the length of the free time (e.g., 15 minutes), and determines a task to be completed within the free time (e.g., “vacuuming” task).

For example, the information processing apparatus 100 streams voice “Would you like to clean room within approximately 10 minutes by the time Mother finishes cooking?” from the smartphone 240 of the “son”. As described above, the information processing apparatus 100 may present task information including the required time of the task.

At this time, a time shorter than the usual required time (15 minutes) of the “son” may be presented as the required time. For example, when a practice mode is set as an execution mode of the “vacuuming” task of the “son”, the information processing apparatus 100 may set a time shorter than the actual required time of the “son” as the required time of the task. In this case, for example, in order to complete the task within the presented time, the information processing apparatus 100 may present guidance information for performing guidance for a task execution speed, such as “There are two minutes remaining. Let's hurry a little.” and “Let's vacuum this room within three minutes.”, during task execution.

Note that a specific user U such as the user U (e.g., “wife”) having administrator authority may set the execution mode. For example, the task DB 162 stores the execution mode. Furthermore, a help mode can be set as the execution mode in addition to the practice mode. A task for which the help mode is set is preferentially assigned to a set specific user U such as the “son”.

As described above, it is assumed that the “son” who has heard the notification “Would you like to clean room within approximately 10 minutes by the time Mother finishes cooking?” from the smartphone 240 moves to the living room L to get the vacuum cleaner 250 and starts cleaning the living room L. In this case, the information processing apparatus 100 detects execution of the “vacuuming” task performed by the “son”.

Here, it is assumed that, although the “husband” who has been watching a favorite TV program on the sofa in the living room L has continued watching the TV program even after the favorite TV program that has been watched ended, the “husband” watches the “son”, and comes up with an idea of the “husband” himself executing a household task. When the “husband” moves to the dressing room, puts laundry into the washing machine 270, presses a switch, and executes washing/drying of the laundry, the information processing apparatus 100 detects a “turning on washing machine to drying” task performed by the “husband”. The information processing apparatus 100 registers a “carrying dried laundry to living room” task in the schedule DB 161 as a derived task based on the detected task and the predicted end time calculated by the washing machine 270.

When the “wife” completes the “cooking” task and three members of the family sit at a table at 19:00, the information processing apparatus 100 presents a result of recognizing an execution user of the “turning on washing machine to drying” task with a low execution user recognition probability. For example, the information processing apparatus 100 projects a sentence “Has father turned on washing machine a short while ago?” by using the moving projector 210 to present the detected task and the recognized execution user. For example, when the “husband” washes a button on which “Yes” is displayed, the information processing apparatus 100 recognizes the “husband” as the execution user of the “turning on washing machine to drying” task.

As described above, the information processing apparatus 100 presents a detected task and a recognized execution user, whereby the user U can easily correct a recognition result of the information processing apparatus 100. Furthermore, a result is presented to a place which other users are at, such as a table with all family members, whereby the other users can confirm the task performed by the execution user. This makes it easier for the other users to express their appreciation to the execution user.

It is assumed that, after dinner, the “husband” is working in the main bedroom R1 and the “son” is loosely operating the smartphone 240 for nothing in the living room L. Furthermore, the “wife” is assumed to sit on the sofa in living room L in a relaxed way and be drinking tea.

For example, when the information processing apparatus 100 refers to the schedule DB 161 and determines that the time to the start time of the next task (here, derived task of “carrying dried laundry to living room”) is less than a predetermined threshold, the information processing apparatus 100 presents the task. At this time, the information processing apparatus 100 presents a task to the user U detected to be in free time (here, “wife” and “son”), and does not present the task to the user U determined not to be in free time (here, “husband”).

Specifically, the information processing apparatus 100 presents a task of “Drying is about to end. Would you like to carry laundry to living room?” by voice from the smartphone 240 of the “son”, for example. Furthermore, the information processing apparatus 100 performs similar presentation to the “wife” by using the moving projector 210. The “son” and the “wife” to whom the task is presented can carry the dried laundry to the living room L at the timing when the washing machine 270 completes drying clothes.

As described above, the information processing apparatus 100 detects free time of the user U and presents a task to the detected user U, whereby efficient task execution using the free time of the user U can be presented. This allows the user U to efficiently execute the task. Furthermore, notifying other users of the task executed by the user U makes it possible to provide the user U with an opportunity for the other users to express appreciation to the execution user and an opportunity for communication between the users U.

### 2. Other Configuration Examples

Each of the above-described configurations is one example. The information processing system 1 may have any system configuration as long as the information processing system 1 can execute the task registration processing and the task presentation processing. For example, the information processing apparatus 100 and the moving projector 210 may be integrated.

Furthermore, among pieces of processing described in the above-described embodiment, all or part of the processing described as being performed automatically can be performed manually, or all or part of the processing described as being performed manually can be performed automatically by a known method. In addition, the processing procedures, the specific names, and the information including various pieces of data and parameters in the above document and drawings can be optionally changed unless otherwise specified. For example, various pieces of information in each figure are not limited to the illustrated information.

Furthermore, each component of each illustrated apparatus is functional and conceptual, and does not necessarily need to be physically configured as described. That is, the specific form of distribution/integration of each apparatus is not limited to the illustrated form, and all or part of the apparatus can be configured in a functionally or physically distributed/integrated manner in any unit in accordance with various loads and use situations.

Furthermore, the series of processing performed by each apparatus described in the present specification may be performed by using any of software, hardware, and a combination of software and hardware. For example, a recording medium (non-transitory medium) provided inside or outside each apparatus preliminarily stores a program constituting software. Then, each program is read into a RAM at the time of execution performed by a computer, and executed by a processor such as a CPU, for example.

Furthermore, the processing described by using the flowcharts in the present specification is not necessarily required to be executed in the illustrated order. Some processing steps may be performed in parallel. Furthermore, an additional processing step may be adopted, or some processing steps may be omitted.

Furthermore, the effects set forth in the present specification are merely examples and not limitations. Other effects may be exhibited.

### 3. Hardware Configuration

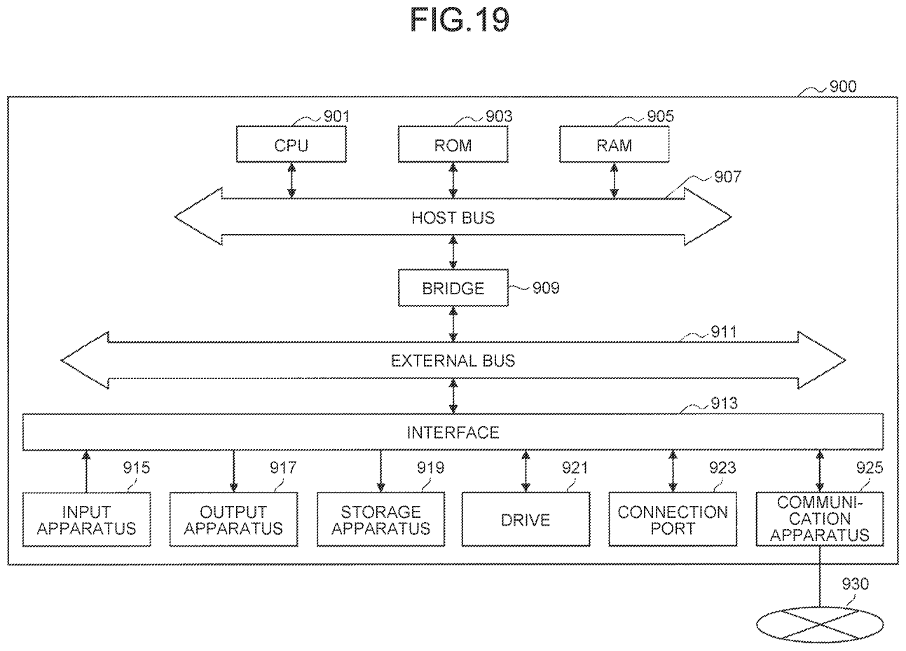

A hardware configuration example of the information processing apparatus according to the present embodiment will be described below with reference to FIG. 19. FIG. 19 is a block diagram illustrating a hardware configuration example of the information processing apparatus according to the present embodiment. Note that an information processing apparatus 900 in FIG. 19 can implement the information processing system 1 in FIG. 2, for example. The information processing system 1 according to the present embodiment implements information processing by cooperation of software and hardware to be described below.

As illustrated in FIG. 19, the information processing apparatus 900 includes a central processing unit (CPU) 901, a read only memory (ROM) 903, and a random access memory (RAM) 905. Furthermore, the information processing apparatus 900 includes a host bus 907, a bridge 909, an external bus 911, an interface 913, an input apparatus 915, an output apparatus 917, a storage apparatus 919, a drive 921, a connection port 923, and a communication apparatus 925. Note that the hardware configuration illustrated here is one example, and some of the components may be omitted. Furthermore, the hardware configuration may further include components other than the components illustrated here.

The CPU 901 functions as, for example, an arithmetic processing apparatus or a control apparatus, and controls the overall or part of the operation of each component based on various programs recorded in the ROM 903, the RAM 905, or the storage apparatus 919. The ROM 903 is a device that stores a program read by the CPU 901, data used for calculation, and the like. The RAM 905 temporarily or permanently stores, for example, a program read by the CPU 901, various parameters that appropriately change at the time of execution of the program, and the like. These components are mutually connected by the host bus 907 including a CPU bus and the like. The CPU 901, the ROM 903, and the RAM 905 can implement the function of the control unit 170 described with reference to FIG. 2, for example, by cooperation with software.

The CPU 901, the ROM 903, and the RAM 905 are mutually connected via, for example, the host bus 907 capable of high-speed data transmission. In contrast, the host bus 907 is connected to the external bus 911 having a relatively low data transmission speed via the bridge 909, for example. Furthermore, the external bus 911 is connected to various components via the interface 913.

The input apparatus 915 is implemented by an apparatus to which information is input by the user, such as a mouse, a keyboard, a touch panel, a button, a microphone, a switch, and a lever. Furthermore, for example, the input apparatus 915 may be a remote-control apparatus using infrared rays or other radio waves, or may be an external connection device, such as a mobile phone and a PDA, compliant with the operation of the information processing apparatus 900. Moreover, for example, the input apparatus 915 may include an input control circuit and the like, which generates an input signal with the above-described input device based on information input by a user and outputs the input signal to the CPU 901. The user of the information processing apparatus 900 can input various pieces of data or give an instruction for processing operation to the information processing apparatus 900 by operating the input apparatus 915.

In addition, the input apparatus 915 can be formed by an apparatus that detects information on a user. For example, the input apparatus 915 may include various sensors such as an image sensor (e.g., camera), a depth sensor (e.g., stereo camera), an acceleration sensor, a gyro sensor, a geomagnetic sensor, an optical sensor, a sound sensor, a distance measurement sensor, and a force sensor. Furthermore, the input apparatus 915 may acquire information on the state of the information processing apparatus 900, such as the posture and moving speed of the information processing apparatus 900, and information on the surrounding environment of the information processing apparatus 900, such as brightness and noise around the information processing apparatus 900. Furthermore, the input apparatus 915 may include a global navigation satellite system (GNSS) module that receives a GNSS signal (e.g., global positioning system (GPS) signal from GPS satellite) from a GNSS satellite and measures position information including the latitude, longitude, and altitude of the apparatus. Furthermore, in relation to the position information, the input apparatus 915 may detect a position by Wi-Fi (registered trademark), transmission and reception to and from mobile phone/PHS/smartphone, or near field communication. The input apparatus 915 can implement the function of the sensor apparatus 300 described with reference to FIG. 2, for example.

The output apparatus 917 is formed by an apparatus capable of visually or auditorily notifying the user of the acquired information. Examples of such an apparatus include a display apparatus, a voice output apparatus, a printer apparatus, and the like. The display apparatus includes a CRT display apparatus, a liquid crystal display apparatus, a plasma display apparatus, an EL display apparatus, a laser projector, an LED projector, a lamp, and the like. The voice output apparatus includes a speaker, a headphone, and the like. The output apparatus 917 outputs results obtained by various pieces of processing performed by the information processing apparatus 900, for example. Specifically, the display apparatus visually displays results obtained by various pieces of processing performed by the information processing apparatus 900 in various formats such as text, images, tables, and graphs. In contrast, the voice output apparatus converts an audio signal including data on reproduced voice, acoustic data, and the like into an analog signal, and auditorily outputs the analog signal. The output apparatus 917 can implement the function of the output apparatus 200 in FIG. 2, for example.

The storage apparatus 919 is formed as one example of a storage unit of the information processing apparatus 900, and stores data. The storage apparatus 919 is implemented by, for example, a magnetic storage unit device such as an HDD, a semiconductor storage device, an optical storage device, a magneto-optical storage device, or the like. The storage apparatus 919 may include a storage medium, a recording apparatus, a reading apparatus, a deletion apparatus, and the like. The recording apparatus records data in the storage medium. The reading apparatus reads data from the storage medium. The deletion apparatus deletes data recorded in the storage medium. The storage apparatus 919 stores programs executed by the CPU 901, various pieces of data, various pieces of data acquired from the outside, and the like. The storage apparatus 919 can achieve the function of the storage unit 160 described with reference to FIG. 2, for example.

The drive 921 is a reader/writer for a storage medium, and is built in or externally attached to the information processing apparatus 900. The drive 921 reads information recorded in a removable storage medium mounted on the drive 921 itself, such as a magnetic disk, an optical disk, a magneto-optical disk, and a semiconductor memory, and outputs the information to the RAM 905. Furthermore, the drive 921 can also write information in the removable storage medium.

The connection port 923 connects an external connection device. The connection port 923 includes, for example, a universal serial bus (USB) port, an IEEE 1394 port, a small computer system interface (SCSI), an RS-232C port, and an optical audio terminal, for example.

The communication apparatus 925 is a communication interface formed by, for example, a communication device for connection with a network 930. The communication apparatus 925 is, for example, a communication card for a wired or wireless local area network (LAN), long term evolution (LTE), Bluetooth (registered trademark), a wireless USB (WUSB), and the like. Furthermore, the communication apparatus 925 may be a router for optical communication, a router for an asymmetric digital subscriber line (ADSL), a modem for various pieces of communication, and the like. For example, the communication apparatus 925 can transmit and receive a signal and the like over the Internet or to and from the Internet and other communication devices in accordance with a predetermined protocol such as TCP/IP.

Note that the network 930 is a wired or wireless transmission path for information transmitted from an apparatus connected to the network 930. For example, the network 930 may include a public network such as the Internet, a telephone network, and a satellite communication network, various local area networks (LANs) including Ethernet (registered trademark), a wide area network (WAN), and the like. Furthermore, the network 930 may include a dedicated network such as an Internet protocol-virtual private network (IP-VPN).

The hardware configuration example of the information processing apparatus according to the present embodiment has been described above with reference to FIG. 19. Each of the above-described components may be implemented by using a general-purpose member or by hardware specialized for the function of each component. Therefore, the hardware configuration to be used can be appropriately changed in accordance with the technical level at the time of carrying out the present embodiment.

Note that the present technology can also have the configurations as follows.

(1)
An information processing apparatus comprising
a control unit that:
detects free time of a user based on behavior information on behavior of the user; and
when the free time is detected, determines a task to be presented to the user from a plurality of tasks.
   (2)
The information processing apparatus according to (1),
wherein the control unit:
acquires schedule information on the user as the behavior information; and
detects free time of the user based on the schedule information.
   (3) The information processing apparatus according to (1) or (2),
wherein the control unit
detects free time of the user based on the behavior information indicating posture information on the user.
   (4)
The information processing apparatus according to any one of (1) to (3),
wherein, when detecting the free time, the control unit
determines the task to be completed within the free time.
   (5)
The information processing apparatus according to any one of (1) to (4),
wherein, when detecting the free time, the control unit
determines the task in accordance with recommendation s of the task.
   (6)
The information processing apparatus according to any one of (1) to (5),
wherein the control unit:
acquires a surrounding situation of the user; and
when detecting the free time, determines the task to be presented to the user based on the surrounding situation.
   (7)
The information processing apparatus according to (6),
wherein the control unit:
acquires behavior information on a user other than the user as a surrounding situation of the user; and
determines the task to be presented to the user based on the behavior information on the other user.
   (8)
The information processing apparatus according to any one of (1) to (7),
wherein, when detecting the free time, the control unit
determines the task to be presented to the user based on labor for executing the task.
   (9)
The information processing apparatus according to any one of (1) to (8),
wherein the control unit:
detects the free time of a user other than the user; and
determines the task to be presented to the user based on a number of other users whose free time is detected at a same time as the free time.
   (10)
The information processing apparatus according to (9)
wherein the control unit:
detects the free time based on behavior information on the other user; and
when detecting the free time of the other user, determines the task to be presented to the user in order from a task which requires a small number of people for executing the task among the plurality of tasks allowed to be presented to the other user.
   (11)
The information processing apparatus according to (9) or (10),
wherein the control unit:
acquires task information on a task being executed by the other user from behavior information on the other user;
when detecting the free time of the user, estimates an end time of the free time based on information on the task being executed by the other user; and
determines the task to be presented to the user based on the end time.
   (12)
The information processing apparatus according to any one of (9) to (11),
wherein the control unit
registers a schedule generated by the task being executed by the other user in schedule management of the user based on the task information.
   (13)
The information processing apparatus according to any one of (9) to (12),
wherein the control unit
determines a task related to the task being executed by the other user as the task to be presented to the user.
   (14)
The information processing apparatus according to any one of (1) to (12),
wherein the control unit
determines the task based on relation between a place where the task is executed and the user.
   (15)
The information processing apparatus according to (14),
wherein the relation between a place where the task is executed and the user is whether or not the user has a right to enter the place where the task is executed.
   (16)
The information processing apparatus according to any one of (1) to (15),
wherein the control unit
presents a determined task to the user by causing a projection device to project information on the determined task.
   (17)
The information processing apparatus according to any one of (1) to (16),
wherein the control unit:
generates guidance information for guiding the user to a task execution place that has been determined;
causes a presentation device to present the guidance information; and
when the user moves to an outside of a presentation range of the presentation device, presents the guidance information to the user with a device different from the presentation device.
   (18)
The information processing apparatus according to any one of (1) to (17),
wherein, when the task execution place is located outside a presentation range of a presentation device that presents the task, the control unit
generates guidance information for guiding the user to a route within the presentation range among routes to the execution place.
   (19)
An information processing method, by a computer, comprising:
detecting free time of a user based on behavior information on behavior of the user; and
when the free time is detected, determining a task to be presented to the user from a plurality of tasks.
   (20)
A program causing a computer to function as
a control unit that:
detects free time of a user based on behavior information on behavior of the user; and
when the free time is detected, determines a task to be presented to the user from a plurality of tasks.

### REFERENCE SIGNS LIST

1 INFORMATION PROCESSING SYSTEM
100 INFORMATION PROCESSING APPARATUS
110 I/F UNIT
160 STORAGE UNIT
170 CONTROL UNIT
120 POSTURE DETECTION UNIT
130 USER DETECTION UNIT
140 ENVIRONMENT DETECTION UNIT
150 DEVICE DETECTION UNIT
171 TASK DETECTION UNIT
172 TASK REGISTRATION UNIT
173 FREE TIME ESTIMATION UNIT
174 TASK SELECTION UNIT
175 OUTPUT CONTROL UNIT

1. An information processing apparatus comprising
a control unit that:
detects free time of a user based on behavior information on behavior of the user; and
when the free time is detected, determines a task to be presented to the user from a plurality of tasks.

2. The information processing apparatus according to claim 1,
wherein the control unit:
acquires schedule information on the user as the behavior information; and
detects free time of the user based on the schedule information.

3. The information processing apparatus according to claim 1,
wherein the control unit
detects free time of the user based on the behavior information indicating posture information on the user.

4. The information processing apparatus according to claim 1,
wherein, when detecting the free time, the control unit
determines the task to be completed within the free time.

5. The information processing apparatus according to claim 1,
wherein, when detecting the free time, the control unit
determines the task in accordance with recommended start time of the task.

6. The information processing apparatus according to claim 1,
wherein the control unit:
acquires a surrounding situation of the user; and
when detecting the free time, determines the task to be presented to the user based on the surrounding situation.

7. The information processing apparatus according to claim 6,
wherein the control unit:
acquires behavior information on a user other than the user as a surrounding situation of the user; and
determines the task to be presented to the user based on the behavior information on the other user.

8. The information processing apparatus according to claim 1,
wherein, when detecting the free time, the control unit
determines the task to be presented to the user based on labor for executing the task.

9. The information processing apparatus according to claim 1,
wherein the control unit:
detects the free time of a user other than the user; and
determines the task to be presented to the user based on a number of other users whose free time is detected at a same time as the free time.

10. The information processing apparatus according to claim 9
wherein the control unit:
detects the free time based on behavior information on the other user; and
when detecting the free time of the other user, determines the task to be presented to the user in order from a task which requires a small number of people for executing the task among the plurality of tasks allowed to be presented to the other user.

11. The information processing apparatus according to claim 9,
wherein the control unit:
acquires task information on a task being executed by the other user from behavior information on the other user;
when detecting the free time of the user, estimates an end time of the free time based on information on the task being executed by the other user; and
determines the task to be presented to the user based on the end time.

12. The information processing apparatus according to claim 11,
wherein the control unit
registers a schedule generated by the task being executed by the other user in schedule management of the user based on the task information.

13. The information processing apparatus according to claim 12,
wherein the control unit
determines a task related to the task being executed by the other user as the task to be presented to the user.

14. The information processing apparatus according to claim 1,
wherein the control unit
executes the task based on relation between a place where the task is executed and the user.

15. The information processing apparatus according to claim 14,
wherein the relation between a place where the task is executed and the user is whether or not the user has a right to enter the place where the task is executed.

16. The information processing apparatus according to claim 1,
wherein the control unit
presents a determined task to the user by causing a projection device to project information on the determined task.

17. The information processing apparatus according to claim 1,
wherein the control unit:
generates guidance information for guiding the user to a task execution place that has been determined;
causes a presentation device to present the guidance information; and
when the user moves to an outside of a presentation range of the presentation device, presents the guidance information to the user with a device different from the presentation device.

18. The information processing apparatus according to claim 1,
wherein, when the task execution place is located outside a presentation range of a presentation device that presents the task, the control unit
generates guidance information for guiding the user to a route within the presentation range among routes to the execution place.

19. An information processing method, by a computer, comprising:
detecting free time of a user based on behavior information on behavior of the user; and
when the free time is detected, determining a task to be presented to the user from a plurality of tasks.

20. A program causing a computer to function as
a control unit that:
detects free time of a user based on behavior information on behavior of the user; and
when the free time is detected, determines a task to be presented to the user from a plurality of tasks.
